(19) United States
(12) Patent Application Publication
(10) Pub. No.: US 2025/0048434 A1
(43) Pub. Date: Feb. 6, 2025

(54) METHOD AND APPARATUS FOR CONTROLLING BASE STATION IN WIRELESS COMMUNICATION SYSTEM

(71) Applicant: Samsung Electronics Co., Ltd., Suwon-si, Gyeonggi-do (KR)

(72) Inventors: Youngbum KIM, Suwon-si (KR); Younsun KIM, Suwon-si (KR)

(21) Appl. No.: 18/718,289

(22) PCT Filed: Feb. 9, 2023
(86) PCT No.: PCT/KR2023/001920

§ 371 Date: Jun. 10, 2024

(30) Foreign Application Priority Data
Feb. 9, 2022 (KR) 10-2022-0016690

(51) Int. Cl. H04W 74/0833; H04W 64/00

(52) U.S. Cl. CPC H04W 74/0833; H04W 64/003

(57) ABSTRACT

The disclosure relates to a 5G or 6G communication system for supporting a higher data transmission rate. According to various embodiments of the present disclosure, a method performed by a first transmission reception point (TRP) in a wireless communication system comprises the steps of: transmitting, to a terminal, a first signal including information about one or more TRPs operating in a frequency band differing from that of the first TRP; receiving, from the terminal, a random access preamble including information about at least one TRP that is preferred by the terminal and determined on the basis of the first signal; transmitting a signal instructing the second TRP to switch to a switch-on state if the first TRP determines the second TRP on the basis of the information about the at least one TRP; and transmitting a signal instructing the terminal to perform a random access procedure with the second TRP.

### TECHNICAL FIELD

The disclosure generally relates to a wireless communication system and, more specifically, a method and an apparatus for controlling a base station in a wireless communication system.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

On the basis of the discussion made above, the disclosure provides a method and an apparatus for controlling a base station in a wireless communication system.

### Solution to Problem

According to various embodiments of the disclosure, a first transmission reception point (TRP) in a wireless communication system may include at least one transceiver and a controller coupled to the at least one transceiver, wherein the controller is configured to transmit, to a terminal, a first signal including information on one or more TRPs operating in a frequency band differing from that of the first TRP, receive, from the terminal, a random access preamble including information on at least one TRP that is preferred by the terminal and determined based on the first signal, in case that the first TRP determines, based on the information on the at least one TRP, a second TRP, transmit a signal instructing the second TRP to switch to a switch-on state, and transmit a signal instructing the terminal to perform a random access procedure with the second TRP.

According to various embodiments of the disclosure, a second transmission reception point (TRP) in a wireless communication system may include at least one transceiver and a controller coupled to the at least one transceiver, wherein the controller is configured to receive a signal instructing to switch a switch state of the second TRP, perform, based on the received signal, switching of the switch state, in case that the switched switch state corresponds to a state in which transmission and reception functions of the second TRP are activated, transmit a first signal to a terminal, and receive, based on the first signal, a random access preamble from the terminal.

### Advantageous Effects of Invention

An apparatus and a method according to various embodiments of the disclosure may provide and a method and an apparatus for controlling a base station in a wireless communication system.

Advantageous effects obtainable from the disclosure may not be limited to the above-mentioned effects, and other effects which are not mentioned may be clearly understood, through the following descriptions, by those skilled in the art to which the disclosure pertains.

### BRIEF DESCRIPTION OF DRAWINGS

FIG. 1 illustrates an example of a basic structure of a time-frequency domain of a 5G system.

FIG. 2 illustrates an example of a time domain mapping structure and a beam sweeping operation for a synchronization signal

FIG. 3 illustrates an example of a random access procedure.

FIG. 4 illustrates an example of a procedure in which a UE reports UE capability information to a base station.

FIG. 5 illustrates a correlation between a frequency band, a coverage, and a bandwidth.

FIG. 6 illustrates an example of a communication system including an access carrier and a data carrier.

FIG. 7 illustrates an example of an operation scenario of a communication system including an access carrier and a data carrier.

FIG. 8 illustrates an example of an operation scenario of a communication system including an access carrier and a data carrier.

FIG. 9 illustrates an example of an operation scenario of a communication system including an access carrier and a data carrier.

FIG. 10 illustrates an example of a random access procedure in a wireless communication system according to various embodiments of the disclosure.

FIG. 11 illustrates an example of a random access procedure in a wireless communication system according to various embodiments of the disclosure.

FIG. 12 illustrates an example of a random access procedure in a wireless communication system according to various embodiments of the disclosure.

FIG. 13 illustrates an example of a correlation between a random access preamble and a data carrier.

FIG. 14 illustrates an example of a correlation between a random access preamble and a data carrier.

FIG. 15 illustrates a correlation between a random access preamble and a data carrier.

FIG. 16 illustrates an example of a UE procedure in a wireless communication system according to various embodiments of the disclosure.

FIG. 17 illustrates an example of an access carrier procedure in a wireless communication system according to various embodiments of the disclosure.

FIG. 18 illustrates an example of a data carrier procedure in a wireless communication system according to various embodiments of the disclosure.

FIG. 19 illustrates an example of a data carrier procedure in a wireless communication system according to various embodiments of the disclosure.

FIG. 20 illustrates UE transmission and reception devices in a wireless communication system according to various embodiments of the disclosure.

FIG. 21 illustrates an example of a configuration of a UE in a wireless communication system according to various embodiments of the disclosure.

FIG. 22 illustrates an example of a configuration of a base station in a wireless communication system according to various embodiments of the disclosure.

### MODE FOR THE INVENTION

Hereinafter, embodiments of the disclosure will be described in detail with reference to the accompanying drawings. In describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in the embodiments may include one or more processors.

In the following description of the disclosure, detailed descriptions of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, the terms “physical channel” and “signal” may be interchangeably used with the term “data” or “control signal”. For example, the term “physical downlink shared channel (PDSCH)” refers to a physical channel over which data is transmitted, but the PDSCH may also be used to refer to the “data”. That is, in the disclosure, the expression “transmit ting a physical channel” may be construed as having the same meaning as the expression “transmitting data or a signal over a physical channel”.

In the following description of the disclosure, upper signaling refers to a signal transfer scheme from a base station to a terminal via a downlink data channel of a physical layer, or from a terminal to a base station via an uplink data channel of a physical layer. The upper signaling may also be understood as radio resource control (RRC) signaling or a media access control (MAC) control element (CE).

In the following description of the disclosure, terms and names defined in the 3rd generation partnership project long term evolution (3GPP LTE) standards will be used for the sake of descriptive convenience. However, the disclosure is not limited by these terms and names, and may be applied in the same way to systems that conform other standards. In addition, the term “terminal” may refer to not only cellular phones, smartphones, IoT devices, and sensors, but also other wireless communication devices.

In the following description, a base station is an entity that allocates resources to terminals, and may be at least one of a gNode B, a gNB, an eNode B, an eNB, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, the examples given above are not limiting.

Recently, in order to handle explosively growing mobile data traffic, an initial standard for a 5th generation (5G) system or new radio (NR) access technology, which is a next-generation communication system after long term evolution (LTE) or evolved universal terrestrial radio access (E-UTRA) and LTE-Advanced (LTE-A) or E-UTRA evolution, has been finalized. While the existing mobile communication systems focused on general voice/data communication, 5G systems aim to satisfy various services and requirements, such as enhanced Mobile BroadBand (eMBB) services for improving the existing voice/data communication, Ultra-Reliable and Low Latency Communication (URLLC) services, massive MTC (mMTC) services for supporting communication between a massive number of devices, etc.

In contrast to legacy LTE and LTE-A systems where a maximum system transmission bandwidth per carrier is limited to 20 MHz, 5G systems mainly aim at provide data services at ultra-high speeds of several Gbps by using a ultrawide bandwidth that is much wider than the transmission bandwidth of the legacy LTE and LTE-A systems. Accordingly, for the 5G systems, an ultra-high frequency band from several GHz up to 100 GHz, in which frequencies having ultrawide bandwidths are easily made available, is being considered as a candidate frequency. Additionally, wide-bandwidth frequencies for the 5G systems may be obtained by reassigning or allocating frequencies among frequency bands included in a range of several hundreds of MHz to several GHz used by the existing mobile communication systems.

A radio wave in the ultra-high frequency band has a wavelength of several millimeters (mm) and is also referred to as a millimeter wave (mmWave). However, in the ultra-high frequency band, a pathloss of radio waves increases with an increase in frequency, and thus a coverage range of a mobile communication system is reduced.

In order to overcome the reduction in coverage in the ultra-high frequency band, a beamforming technology is applied to increase a radio wave arrival distance by focusing a radiation energy of radio waves to a certain target point using a plurality of antennas. In other words, a signal to which the beamforming technology is applied has a relatively narrow beamwidth, and radiation energy is concentrated within the narrow beam width, so that the radio wave arrival distance is increased. The beamforming technology may be applied at both a transmitter and a receiver. In addition to increasing the coverage range, the beamforming technology also has an effect of reducing interference in a region other than a beamforming direction. To properly implement the beamforming technology, an accurate transmit/receive beam measurement and feedback method is required. The beamforming technology may be applied to a control channel or a data channel having a one-to-one correspondence between a certain UE and a base station. In addition, to increase coverage, the beamforming technology may be applied for control channels and data channels via which the base station transmits, to multiple UEs in a system, common signals such as a synchronization signal, a physical broadcast channel (PBCH), and system information. When the beamforming technology is applied to the common signals, a beam sweeping technique for transmitting a signal by changing a beam direction is additionally applied to allow the common signals to reach a UE located at any position within a cell.

As another requirement for the 5G systems, an ultra-low latency service with a transmission delay about 1 ms between a transmitter and a receiver is required. As a method for reducing the transmission delay, a frame structure based on a short transmission time interval (TTI) compared to that in LTE and LTE-A needs to be designed. A TTI is a basic time unit for performing scheduling, and a TTI in the legacy LTE and LTE-A systems corresponds to one subframe with a length of 1 ms. For example, as a short TTI for satisfying the requirement for the ultra-low latency service in the 5G systems, TTIs of 0.5 ms, 0.25 ms, 0.125 ms, etc. that are shorter than the TTI in the legacy LTE and LTE-A systems may be supported.

The disclosure relates to a method and an apparatus for efficient frequency use and base station energy consumption reduction in a wireless communication system.

The disclosure provides a method and an apparatus for reducing a base station energy consumption and efficiently using the frequency in a mobile communication system.

According to an embodiment of the disclosure, a signal transmission method of a base station and a UE in a mobile communication system is defined so that a problem of excessive energy consumption of the base station can be resolved and high energy efficiency can be achieved. In addition, an effect of increasing the frequency efficiency of the mobile communication system can be achieved.

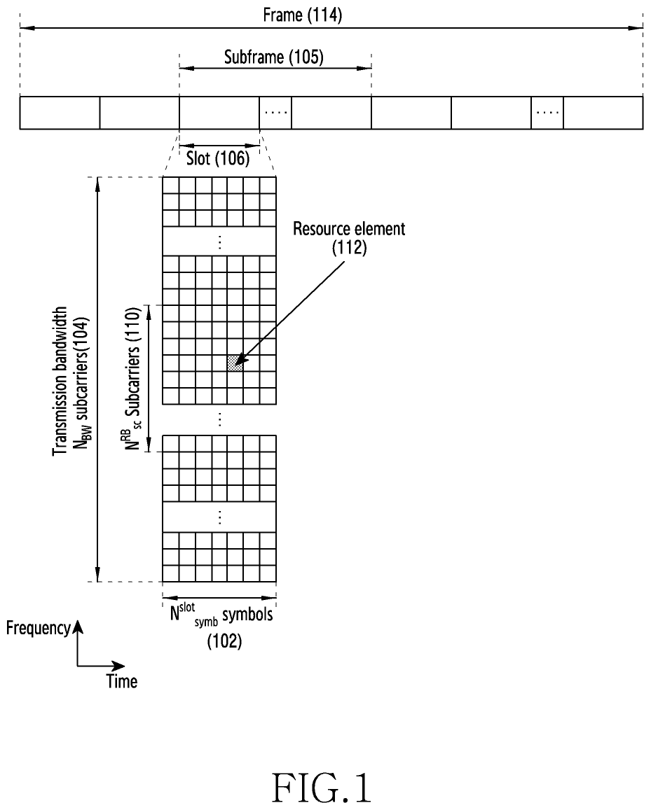

FIG. 1 illustrates an example of a basic structure of a time-frequency domain of a 5G system.

That is, FIG. 1 illustrates a basic structure of a time-frequency resource domain corresponding to a radio resource domain in which a data or control channel of a 5G system is transmitted.

Referring to FIG. 1, in FIG. 1, the horizontal axis represents the time domain, and the vertical axis represents the frequency domain. A minimum transmission unit in the time domain of the 5G system is an orthogonal frequency division multiplexing (OFDM) symbol, N_{symb}^{slot} symbols 102 together may constitute one slot 106, and Nₛₗₒₜ^{subframe} slots together may constitute one subframe 105. The length slot of the subframe is 1.0 ms, and ten subframe together may constitute a 10 ms frame 114. A minimum transmission unit in the frequency domain is a subcarrier, and the bandwidth of a whole system transmission band may include a total of N_{BW} subcarriers 104.

The basic resource unit in the time-frequency domain is a resource element (RE) 112, and may be represented by an OFDM symbol index and a subcarrier index. A resource block (RB) or a physical resource block (PRB) may be defined as N_{sc}^{RB} successive subcarriers 110. In the 5G system, N_{sc}^{RB}=12, and a data rate may increase in proportion to the number of RBs scheduled for the UE.

In the 5G system, the base station may perform data mapping in units of RBs, and in general, may perform scheduling for RBs constituting one slot for a predetermined UE. That is, the basic time unit for scheduling in the 5G system may be a slot, and the basis frequency unit for scheduling may be an RB.

The number N_{symb}^{slot} of OFDM symbols is determined according to the length of a cyclic prefix (CP) added to each symbol to prevent inter-symbol interference, and for example, N_{symb}^{slot}=14 when a normal CP is applied, and N_{symb}^{slot}=12 when an extended CP is applied. The extended CP may be applied to a system having a relatively long radio wave transmission distance compared to that for the normal CP, thereby maintaining orthogonality between symbols. For the normal CP, a ratio of a CP length to a symbol length may be maintained at a constant value to keep an overhead due to the CP constant regardless of a subcarrier spacing. In other words, as a subcarrier spacing becomes narrower, a symbol length may increase, and accordingly, a CP length may increase. On the other hand, as a subcarrier spacing becomes wider, a symbol length may decrease, and accordingly, a CP length may decrease. A symbol length and a CP length may be inversely proportional to a subcarrier spacing.

In the 5G system, in order to satisfy various services and requirements, various frame structures may be supported by adjusting a subcarrier spacing. For example,

In terms of an operating frequency band, a wider subcarrier spacing is more beneficial for recovery from phase noise in a high frequency band.

In terms of a transmission time, when a subcarrier spacing becomes wider, a symbol length in the time domain is shortened, which leads to a shorter slot, and thus the wider subcarrier spacing is more advantageous for supporting ultra-low latency services such as URLLC.

In terms of cell size, a larger cell may be supported as a CP length becomes larger, and thus as a subcarrier becomes narrower, a relatively larger cell may be supported. A cell is a concept indicating an area covered by one BS in mobile communication.

The subcarrier spacing, the CP length, etc. are essential information for OFDM transmission and reception, and the base station and the UE need to recognize the subcarrier spacing, the CP length, etc. as a common value to enable seamless transmission and reception. Table 1 shows a relationship among a subcarrier spacing configuration u, a subcarrier spacing Δf, and a CP length supported in the 5G system.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Table 2 shows the number N_{symb}^{slot} of symbols per slot the number Nₛₗₒₜ^{frame,μ} of slots per frame, and the number Nₛₗₒₜ^{subframe,μ} of slots per subframe for each subcarrier spacing configuration in the case of a normal CP.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 shows the number N_{symb}^{slot} of symbols per slot, the number Nₛₗₒₜ^{frame,μ} of slots per frame, and the number Nₛₗₒₜ^{subframe,μ} of slots per subframe for each subcarrier spacing configuration u in the case of an extended CP.

TABLE 3

| μ | N_{symb}^{slot} | Nₛₗₒₜ^{frame, μ} | Nₛₗₒₜ^{subframe, μ} |
|---|---|---|---|
| 2 | 12 | 40 | 4 |

At an early stage of introduction of the 5G system, at least coexistence or dual mode operation with a legacy LTE and/or LTE-A (hereinafter, referred to as LTE/LTE-A) system is expected. Accordingly, the legacy LTE/LTE-A system may provide a stable system operation to the UE, and the 5G system may provide enhanced services to the UE. Therefore, a frame structure of the 5G system needs to include at least a frame structure or an essential parameter set (subcarrier spacing (SCS)=15 kHz) of the legacy LTE/LTE-A system.

For example, when a frame structure (hereinafter, referred to as frame structure A) in which subcarrier spacing configuration u=0 and a frame structure (hereinafter, referred to as frame structure B) in which subcarrier spacing configuration u=1 are compared to each other, the subcarrier spacing and the RB size of frame structure B become two times larger than those of frame structure A, whereas a slot length and a symbol length of frame structure B become two times smaller than those of frame structure A. In the case of frame structure B, two slots may constitute one subframe, and 20 subframes may constitute one frame.

To generalize the frame structure of the 5G system, the subcarrier spacing, the CP length, the slot length, etc., which correspond to the necessary parameter set, have the relationship of an integer multiple for each frame structure, whereby high expandability is provided. In order to indicate a reference time unit irrelevant to the frame structure, a subframe of a fixed length of 1 ms may be defined.

The frame structures may be applied to correspond to various scenarios. In terms of a cell size, since a larger cell may be supported as a CP length becomes larger, frame structure A may support a relatively large cell compared to frame structure B. In terms of an operating frequency band, since a wider subcarrier spacing is more beneficial for recovery from phase noise in a high frequency band, frame structure B may support a relatively high operating frequency compared to frame structure A. From a service perspective, since a smaller length of a slot as a basic scheduling unit is more advantageous for supporting ultra-low latency services such as URLLC, frame structure B may be more suitable for a URLLC service than frame structure A.

As used below in various embodiments of the disclosure, an uplink may refer to a radio link via which a user equipment transmits data or control signals to a base station, and a downlink may refer to a radio link via which a base station transmits data or control signals to a user equipment.

In an initial access step in which a user equipment initially accesses a system, the user equipment may perform downlink time and frequency domain synchronization and acquire a cell identifier (ID) from a synchronization signal, transmitted by a base station, through a cell search. In addition, the user equipment may receive a physical broadcast channel (PBCH) by using the acquired cell ID and acquire a master information block (MIB) as mandatory system information from the PBCH. Additionally, the user equipment may receive system information (system information block (SIB)) transmitted by the base station to acquire cell-common transmission and reception-related control information. The cell-common transmission and reception-related control information may include random access-related control information, paging-related control information, common control information for various physical channels, etc.

A synchronization signal is a signal that serves as a reference for a cell search, and for each frequency band, a subcarrier spacing may be applied adaptively to a channel environment, such as phase noise. For a data channel or a control channel, in order to support various services as described above, a subcarrier spacing may be applied differently depending on a service type.

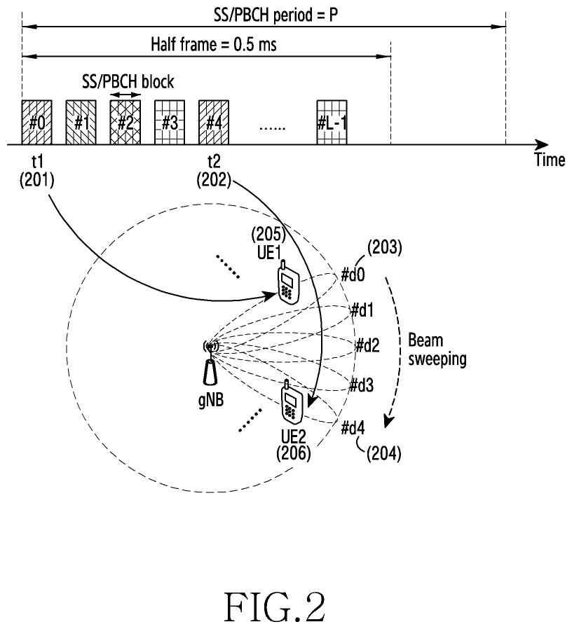

FIG. 2 illustrates an example of a time domain mapping structure and a beam sweeping operation for a synchronization signal.

The following elements may be defined for description.

Primary synchronization signal (PSS): is a signal that serves as a reference for DL time/frequency synchronization and provides part of information for a cell ID.

Secondary synchronization signal (SSS): serves as a reference for DL time/frequency synchronization and provides remaining part of information of a cell ID. Additionally, it may serve as a reference signal for demodulation of PBCH.

Physical broadcast channel (PBCH): provides a master information block (MIB), which is essential system information required for data channel and control channel transmission/reception by the UE. The essential system information may include search space-related control information indicating radio resource mapping information of a control channel, scheduling control information for a separate data channel for transmitting system information, and information, such as system frame number (SFN), which is the frame unit index serving as a timing reference.

Synchronization signal/PBCH block or SSB (SS/PBCH block): The SS/PBCH block is constituted of N OFDM symbols and is composed of a combination of the PSS, SSS, and PBCH. In the case of a system to which beam sweeping technology is applied, the SS/PBCH block is the minimum unit to which beam sweeping is applied. In the 5G system, N=4. The base station may transmit up to L SS/PBCH blocks. The L SS/PBCH blocks are mapped within a half frame (0.5 ms). The L SS/PBCH blocks are periodically repeated every predetermined period P. The base station may inform the UE of the period P via signaling. If there is no separate signaling for the period P, the UE applies a previously agreed default value. The respective SS/PBCH blocks may have SS/PBCH block indices from 0 up to L−1, respectively, and the terminal may identify the SS/PBCH block index through SS/PBCH detection.

Referring to FIG. 2, FIG. 2 illustrates that beam sweeping is applied in units of SS/PBCH blocks over time. In the example of FIG. 2, UE 1 205 receives an SS/PBCH block by using a beam radiated in direction #d0 203 by beamforming applied to SS/PBCH block #0 at time point t1 201. In addition, UE 2 206 receives an SS/PBCH block by using a beam radiated in direction #d4 204 by beamforming applied to SS/PBCH block #4 at time point t2 202. The UE may obtain an optimal synchronization signal via a beam radiated from the BS in a direction toward a location of the UE. For example, it may be difficult for UE 1 205 to obtain time/frequency synchronization and essential system information from an SS/PBCH block via the beam radiated in the direction #d4 504 that is far away from UE 1.

In addition to reception for the initial access procedure, the UE may receive an SS/PBCH block to determine whether a radio link quality of a current cell is maintained at a predetermined level or higher. Furthermore, in a procedure for performing handover of the UE from the current cell to a neighboring cell, the UE may receive an SS/PBCH block from the neighboring cell in order to determine a radio link quality of the neighboring cell and obtain time/frequency synchronization of the neighboring cell.

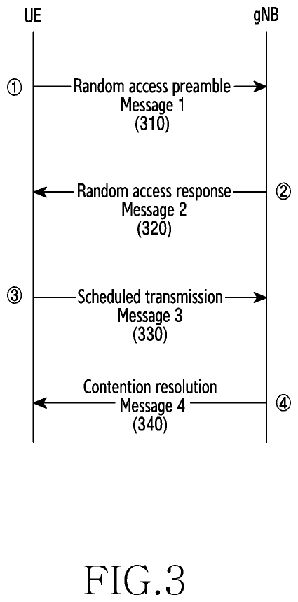

After the UE obtains MIB and system information from the base station through the initial access procedure, the UE may perform a random access procedure to switch a link with the base station to a connected state (or RRC CONNECTED state). Upon completion of the random access procedure, the UE switches to a connected state, and one-to-one communication is enabled between the base station and the UE. Hereinafter, a random access procedure will be described in detail with reference to FIG. 3.

FIG. 3 illustrates an example of a random access procedure.

Referring to FIG. 3, in the first stage 310 of the random access procedure, a UE transmits a random access preamble to a base station. In the random access procedure, the random access preamble, which is an initial transmission message of the UE, may be referred to as message 1. The base station may measure a propagation delay value between the UE and the base station from the random access preamble and achieve uplink synchronization. In this case, the UE may randomly select a random access preamble to be used from a set of random access preambles given by system information in advance. In addition, initial transmission power for the random access preamble may be determined according to a pathloss between the base station and the UE, which is measured by the UE. In addition, the UE may transmit the random access preamble by determining a direction of a transmission beam for the random access preamble, based on a synchronization signal received from the base station.

In the second stage 320, the base station transmits an uplink transmission timing control command to the UE, based on the propagation delay value measured from the random access preamble received in stage 1 310. In addition, the base station may also transmit, to the UE, an uplink resource to be used by the UE and a power control command as scheduling information. Control information of an uplink transmit beam of the UE may be included in the scheduling information.

If the UE fails to receive, from the base station, a random access response (RAR) (or message 2) that is scheduling information for message 3 within a predetermined time interval in the second stage 320, the UE may perform the first step 310 again. If the UE performs the first stage 310 again, the UE may transmit the random access preamble with transmission power increased by a predetermined step (power ramping), thereby increasing the probability of reception of the random access preamble at the base station.

In the third stage 330, the UE transmits uplink data (message 3) including its UE ID to the base station through an uplink data channel (physical uplink shared channel (PUSCH)) by using the uplink resource allocated in the second stage 320. A transmission timing of the uplink data channel for transmitting message 3 may be controlled according to the timing control command received from the base station in the second stage 320. In addition, transmission power for the uplink data channel for transmitting message 3 may be determined in consideration of the power control command received from the base station in the second stage 320 and a power ramping value applied to the random access preamble. The uplink data channel for transmitting message 3 may mean an initial uplink data signal transmitted by the UE to the base station after the UE transmits the random access preamble.

In the fourth stage 340, when the base station determines that the UE has performed the random access procedure without colliding with another UE, the base station may transmit data (message 4) including an ID of the UE that has transmitted the uplink data in the third stage 330 to the corresponding UE. Upon receiving a signal transmitted by the base station in the fourth stage 340, the UE may determine that the random access procedure is successful. In addition, the UE may transmit, to the base station, HARQ-ACK information indicating whether message 4 has been successfully received, through an uplink control channel (physical uplink control channel (PUCCH)).

If the data transmitted by the UE in the third stage 330 collides with data transmitted by another UE and thus the base station fails to receive a data signal from the UE, the base station may no longer transmit data to the UE. Accordingly, if the UE fails to receive the data transmitted by the BS in the fourth stage 340 within a predetermined time interval, the UE may determine that the random access procedure has failed and may restart the random access procedure from the first stage 310.

Upon successful completion of the random access procedure, the UE may transition to a connected state, and one-to-one communication between the base station and UE is enabled. The base station may receive UE capability information from the UE in the connected state and adjust scheduling based on the UE capability information of the corresponding UE. The UE may inform, via the UE capability information, the base station of whether the UE itself supports a predetermined functionality, a maximum allowable value of the functionality supported by the UE, etc. Accordingly, the UE capability information reported by each UE to the base station may have a different value for each UE.

As an example, the UE may report, to the base station, UE capability information including at least some of the following control information as the UE capability information.

Control information related to a frequency band supported by the UE

Control information related to a channel bandwidth supported by the UE

Control information related to a maximum modulation scheme supported by the UE

Control Information related to a maximum number of beams supported by the UE

Control information related to a maximum number of layers supported by the UE

Control information related to CSI reporting supported by the UE

Control information of whether the UE supports frequency hopping

Control information related to a bandwidth when carrier aggregation (CA) is supported

Control information of whether cross-carrier scheduling is supported when CA is supported

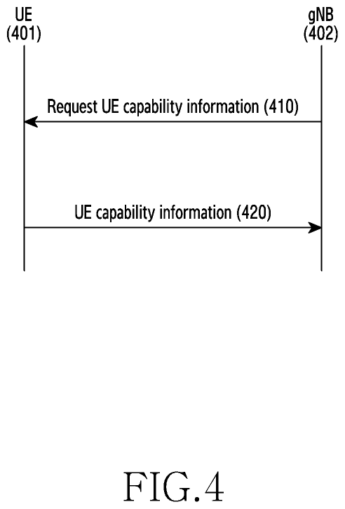

FIG. 4 illustrates an example of a procedure in which a UE reports UE capability information to a base station.

Referring to FIG. 4, in stage 410, a base station 402 may transmit a UE capability information request message to a UE 401. In response, the UE 401 transmits UE capability information to the base station 402 in stage 420.

Hereinafter, a scheduling method in which the base station transmits downlink data to the UE and indicates uplink data transmission of the UE is described.

Downlink control information (DCI) is control information transmitted to the UE through downlink by the base station, and may include downlink data scheduling information or uplink data scheduling information for a predetermined UE. In general, the base station may independently channel-code DCI for each UE and then may transmit the same to each UE via a physical downlink control channel (PDCCH) that is a downlink physical control channel.

The base station may apply and operate a predefined DCI format for a UE to be scheduled according to purposes such as whether DCI carries scheduling information for downlink data (downlink assignment), whether the DCI carries scheduling information for uplink data (uplink grant), whether the DCI is DCI for power control, etc.

The base station may transmit downlink data to the UE via a physical downlink shared channel (PDSCH), which is a physical channel for downlink data transmission. The base station may inform the UE of scheduling information, such as a specific mapping location of the PDSCH in the time-frequency domain, a modulation scheme, HARQ-associated control information, power control information, etc., via DCI related to downlink data scheduling information among DCIs transmitted on the PDCCH.

The UE may transmit uplink data to the base station via a physical uplink shared channel (PUSCH), which is a physical channel for uplink data transmission. The base station may inform the UE of scheduling information, such as a specific mapping location of the PUSCH in the time-frequency domain, a modulation scheme, HARQ-associated control information, power control information, etc., via DCI related to UL data scheduling information among DCIs transmitted on the PDCCH.

Time-frequency resources on which a PDCCH is mapped are called a control resource set (CORESET). In the frequency domain, the CORESET may be configured in the whole or partial frequency resource of the bandwidth supped by the UE. In the time domain, the CORESET may be configured as one or multiple OFDM symbols, which may be defined as a CORESET length (control resource set duration). The base station may configure one or multiple CORESETs for the UE via higher-layer signaling (e.g., system information, master information block (MIB), and radio resource control (RRC) signaling). Configuring the CORESET for the terminal may mean that providing information such as a CORESET identity, the frequency position of the CORESET, and the symbol length of the CORESET. Information provided to the UE by the base station to configure the CORESET may include at least one of information included in Table 4.

TABLE 4

| | |
|---|---|
| ControlResourceSet ::= | SEQUENCE { |
| controlResourceSetId | ControlResourceSetId, |

(CORESET identity)

| | |
|---|---|
| frequencyDomainResources | BIT STRING (SIZE (45)), |

(frequency area resource)

| | |
|---|---|
| duration | INTEGER (1..maxCoReSetDuration), |

(CORESET duration)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| interleaverSize | ENUMERATED {n2, n3, n6}, |

```
          (interlearver size)
          shiftIndex
```

| | |
|---|---|
| INTEGER(0..maxNrofPhysicalResourceBlocks-1) | OPTIONAL -- Need S |

```
          (interleaver shift)
      },
```

| | |
|---|---|
| nonInterleaved | NULL |

},

| | |
|---|---|
| precoderGranularity | ENUMERATED {sameAsREG-bundle, |

allContiguousRBs},
(precoding unit

| | |
|---|---|
| tci-StatesPDCCH-ToAddList | SEQUENCE(SIZE (1..maxNrofTCI- |

StatesPDCCH)) OF TCI-StateId OPTIONAL, -- Cond NotSIB1-initialBWP
(QCL configuration information)

| | |
|---|---|
| tci-StatesPDCCH-ToReleaseList | SEQUENCE(SIZE (1..maxNrofTCI- |

StatesPDCCH)) OF TCI-StateId OPTIONAL, -- Cond NotSIB1-initialBWP
(QCL configuration information)

| | |
|---|---|
| tci-PresentInDCI | ENUMERATED {enabled} |

OPTIONAL, -- Need S
(QCL indicator configuration information in DCI)

| | |
|---|---|
| pdcch-DMRS-ScramblingID | INTEGER (0..65535) |

```
OPTIONAL, -- Need S
      (PDCCH DMRS scrambling identifier)
  }
```

A CORESET may include N_{RB}^{CORESET} in the frequency domain and may include N_{symb}^{CORESET}∈{1,2,3} symbols in the time domain. A NR PDCCH may include one or multiple control channel elements (CCEs). One CCE may include six resource element groups (REGs), and each REG may be defined as one RB during one OFDM symbol. The REGs in one CORESET may be numbered in a time-first manner, starting with 0 for the first OFDM symbol and the lowest-numbered RB in the CORESET.

An interleaved method and a non-interleaved method may be supported as a method of transmitting a PDCCH. A base station may configure, for a UE, whether to perform interleaving transmission or non-interleaving transmission for each CORESET by higher-layer signaling. Interleaving may be performed in units of REG bundles. The term “REG bundle” may be defined as a set of one or multiple REGs. The UE may determine a CCE-to-REG mapping method in the CORESET by using a method as in Table 5, based on whether to perform interleaving or non-interleaving transmission configured from the base station.

```
TABLE 5
  The CCE-to-REG mapping for a control-resource set can be interleaved or
non-interleaved and is described by REG bundles:
  - REG bundle i is defined as REGs {iL, iL + 1, . . . , iL + L − 1} where L
is the REG bundle size, i = 0,1, ... , N_{REG}^{CORESET}/L − 1 , and N_{REG}^{CORESET} =
N_{RB}^{CORESET} N_{symb}^{CORESET} is the number of REGs in the CORESET
  - CCE j consists of REG bundles {f(6j/L), f(6j/L + 1), . . . , f(6j/L +
6/L − 1)} where f(•)is an interleaver
  For non-interleaved CCE-to-REG mapping, L = 6 and f(x) = x.
  For interleaved CCE-to-REG mapping, L ∈ {2,6}for N_{symb}^{CORESET} = 1 and L ∈
{N_{symb}^{CORESET}, 6} for N_{symb}^{CORESET} ∈ {2,3}. The interleaver is defined by
    f(x) = (rC + c + n_{shift}) mod (N_{REG}^{CORESET}/L)
        x = cR + r
        r = 0,1, ... , R − 1
        c = 0,1, ... , C − 1
      C = N_{REG}^{CORESET}/(LR)
  where R ∈ {2,3,6}.
```

The base station may inform, by signaling, the UE of a symbol to which a PDCCH is mapped within a slot, configuration information such as transmission periodicity, etc.

A search space of a PDCCH is described as follows. The number of CCEs required to transmit the PDCCH may be 1, 2, 4, 8, or 16 depending on an aggregation level (AL), and different numbers of CCEs may be used to implement link adaptation of the downlink control channel. For example, when the AL=L, one downlink control channel may be transmitted through L CCEs. The UE performs blind decoding to detect a signal without knowing information on the downlink control channel, and thus a search space representing a set of CCEs may be defined for the blind decoding. The search space may be defined as a set of downlink control channel candidates that include CCEs on which the UE should attempt decoding at a given AL, and because there are various ALs each making a bundle with 1, 2, 4, 8, or 16 CCEs, the UE may have multiple search spaces. A search space set may be defined as a set of search spaces at all the configured ALs.

The search spaces may be classified into a common search space (CSS) and a UE-specific search space (USS). A predetermined group of UEs or all the UEs may monitor a CSS of the PDCCH so as to receive dynamic scheduling of a system information block (SIB) or receive cell-common control information such as a paging message. For example, the UE may monitor a CSS of the PDCCH so as to receive PDSCH scheduling allocation information for receiving system information. Because a predetermined group of UEs or all the UEs should receive the PDCCH, the CSS may be defined as a set of pre-defined CCEs. The UE may receive UE-specific PDSCH or PUSCH scheduling allocation information by monitoring a USS of the PDCCH. The USS may be UE-specifically defined as a function of various system parameters and an ID of the UE.

The base station may configure the UE with configuration information of a search space of a PDCCH via higher-layer signaling (e.g., SIB, MIB, or RRC signaling). For example, the base station may configure the UE with the number of PDCCH candidates at each aggregation level L, monitoring periodicity for the search space, monitoring occasion on symbols in the slot for the search space, a type of the search space (CSS or USS), a combination of a DCI format to be monitored in the search space and a RNTI, a CORESET index to monitor the search space, etc. For example, a parameter for the search space of the PDCCH may include information as in Table 6 below.

TABLE 6

| | |
|---|---|
| SearchSpace ::= | SEQUENCE { |
| searchSpaceId | SearchSpaceId, |

(search space identifier)

| | | |
|---|---|---|
| controlResourceSetId | ControlResourceSetId | OPTIONAL, - |

```
- Cond SetupOnly
      (CORESET identifier)
    monitoringSlotPeriodicityAndOffset CHOICE {
      (monitoring slot level periodicity and offset)
```

| sl1 | NULL, | |
|---|---|---|
| sl2 | INTEGER (0..1), | |
| sl4 | INTEGER (0..3), | |
| sl5 | INTEGER (0..4), | |
| sl8 | INTEGER (0..7), | |
| sl10 | INTEGER (0..9), | |
| sl16 | INTEGER (0..15), | |
| sl20 | INTEGER (0..19), | |
| sl40 | INTEGER (0..39), | |
| sl80 | INTEGER (0..79), | |
| sl160 | INTEGER (0..159), | |
| sl320 | INTEGER (0..319), | |
| sl640 | INTEGER (0..639), | |
| sl1280 | INTEGER (0..1279), | |
| sl2560 | INTEGER (0..2559) | |
| } | | OPTIONAL, -- Cond Setup |
| duration | INTEGER (2..2559) | OPTIONAL, |

-- Need R
(monitoring duration)

| | |
|---|---|
| monitoringSymbolsWithinSlot | BIT STRING (SIZE (14)) |

OPTIONAL, -- Cond Setup
(monitoring symbol location in slot)

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, n4, n5, n6, |
| n8}, | |
| aggregationLevel2 | ENUMERATED {n0, n1, n2, n3, n4, n5, n6, |

n8},

| | |
|---|---|
| aggregationLevel4 | ENUMERATED {n0, n1, n2, n3, n4, n5, n6, |

n8},

| | |
|---|---|
| aggregationLevel8 | ENUMERATED {n0, n1, n2, n3, n4, n5, n6, |

n8},

| | |
|---|---|
| aggregationLevel16 | ENUMERATED {n0, n1, n2, n3, n4, n5, n6, |

n8}

| | |
|---|---|
| } | OPTIONAL, -- Cond Setup |

| | |
|---|---|
| searchSpaceType | CHOICE { |

(search space type)

| | |
|---|---|
| common | SEQUENCE { |

(common search space)

| | |
|---|---|
| dci-Format0-0-AndFormat1-0 | SEQUENCE { |

...

| } | | OPTIONAL, -- Need R |
|---|---|---|
| dci-Format2-0 | SEQUENCE { | |
| nrofCandidates-SFI | SEQUENCE { | |
| aggregationLevel1 | ENUMERATED {n1, n2} | OPTIONAL, |

-- Need R

| | | |
|---|---|---|
| aggregationLevel2 | ENUMERATED {n1, n2} | OPTIONAL, |

-- Need R

| | | |
|---|---|---|
| aggregationLevel4 | ENUMERATED {n1, n2} | OPTIONAL, |

-- Need R

| | | |
|---|---|---|
| aggregationLevel8 | ENUMERATED {n1, n2} | OPTIONAL, |

-- Need R

| | | |
|---|---|---|
| aggregationLevel16 | ENUMERATED {n1, n2} | OPTIONAL |

```
-- Need R
          },
          ...
```

| | |
|---|---|
| } | OPTIONAL, -- Need R |

| | |
|---|---|
| dci-Format2-1 | SEQUENCE { |

```
          ...
        }
OPTIONAL, -- Need R
```

| | |
|---|---|
| dci-Format2-2 | SEQUENCE { |

...

| | |
|---|---|
| } | OPTIONAL, -- Need R |

| | |
|---|---|
| dci-Format2-3 | SEQUENCE { |
| dummy1 | ENUMERATED {sl1, sl2, sl4, sl5, sl8, sl10, |

sl16, sl20} OPTIONAL, -- Cond Setup

| | |
|---|---|
| dummy2 | ENUMERATED {n1, n2}, |

...

| | |
|---|---|
| } | OPTIONAL -- Need R |

},

| | |
|---|---|
| ue-Specific | SEQUENCE { |

(UE-specific search space)

| | |
|---|---|
| dci-Formats | ENUMERATED {formats0-0-And-1-0, |

```
formats0-1-And-1-1},
        ...,
      }
```

| | |
|---|---|
| } | OPTIONAL -- Cond Setup2 |

}

According to the configuration information, the base station may configure the UE with one or multiple search space sets. According to some embodiments, the base station may configure search space set 1 and search space set 2 for the UE. The base station may make configuration so that the UE monitors DCI format A scrambled by an X-RNTI in search space set 1 in the CSS and monitors DCI format B scrambled by a Y-RNTI in search space set 2 in the USS.

According to configuration information, one or multiple search space sets may be present in the CSS or the USS. For example, search space set #1 and search space set #2 may be configured as the CSS, and search space set #3 and search space set #4 may be configured as the USS.

n the CSS, the UE may monitor combinations of DCI formats and RNTIs below. The combinations are not limited to the examples below.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the USS, the UE may monitor combinations of DCI formats and RNTIs below may be monitored. The combinations are not limited to an example below.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The RNTIs may conform to definitions and purposes below.

Cell-RINT (C-RNTI): for UE-specific PDSCH or PUSCH scheduling

Temporary cell RNTI (TC-RNTI): for UE-specific PDSCH scheduling

Configured scheduling RNTI (CS-RNTI): for semi-statically configured UE-specific PDSCH scheduling

Random access RNTI (RA-RNTI): for PDSCH scheduling in a random access process

Paging RNTI (P-RNTI): for scheduling a PDSCH on which paging is transmitted

System information RNTI (SI-RNTI): for scheduling a PDSCH on which SI is transmitted

Interruption RNTI (INT-RNTI): for indicating whether to puncture the PDSCH

Transmit power control for PUSCH RNTI (TPC-PUSCH-RNTI): for indicating power control command for a PUSCH

Transmit Power Control for PUCCH RNTI (TPC-PUCCH-RNTI): for indicating power control command for a PUCCH

Transmit Power Control for SRS RNTI (TPC-SRS-RNTI): for indicating power control command for an SRS

The DCI formats described above may conform to definitions as in Table 7 below.

TABLE 7

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

A search space at aggregation level L with CORESET p and search space set s may be represented as shown in the equation below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{p , s , max}^{( L )}} ⌋ + {n}_{CI} ) mod ⌊ {N}_{CCE , p} / L ⌋ \} + i \qquad Equation 1$$

L: aggregation level
n_{CI}: carrier index
N_{CCE,p}: total number of CCEs existing in control resource set p
n^{μ}_{s,f}: slot index
M^{(L)}_{p,s,max}: number of PDCCH candidates of aggregation level L
m_{snCI}=0, . . . , M^{(L)}_{p,s,max}−1: PDCCH candidate indices of aggregation level L
i=0, . . . , L−1

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, A₀=39827, A₁=39829, A₂=39839, D=65537
n_{RNTI}: UE identifier

A value of

$${Y}_{p , {n}_{s , f}^{μ}}$$

may correspond to 0 for CSS.

The value of

$${Y}_{p , {n}_{s , f}^{μ}}$$

may be a value that changes according to a UE ID (C-RNTI or ID configured by the BS for the UE) and time index for the USS.

As a method for supporting the ultrahigh speed service, a data rate can be increased through a spatial multiplexing method using multiple transmission and reception antennas. In general, the number of requested power amplifiers (PAs) increases in proportion to the number of transmission antennas provided at the base station or the UE. A maximum output of each of the base station and the UE depends on a feature of a PA, and in general, a maximum output of the base station varies depending on a cell size covered by the base station. Normally, a maximum output is expressed in a dBm unit. A maximum output of the UE is generally 23 dBm or 26 dBm.

As an example of a commercial-use 5G base station, the base station may have 64 transmission antennas and 64 PAs corresponding thereto in a frequency band of 3.5 GHZ, and may operate in a bandwidth of 100 MHz. That is, energy consumption of the base station increases in proportion to an output of PAs and an operation time of the PAs. Compared to the LTE base station, the 5G base station has a wide bandwidth and many transmission antennas as an operating frequency band of the 5G base station is relatively high. These features have an effect of increasing a data rate but cause costs of large energy consumption of the base station. Therefore, as the number of base stations constituting a mobile communication network increases, the more the energy consumption of the mobile communication network proportionally increases.

As described above, energy consumption of the base station significantly depends on an operation of a PA. As the PA involves a transmission operation of the base station, a downlink (DL) transmission operation of the base station is highly associated with energy consumption of the base station. A portion of an uplink (UL) reception operation of the base station is not relatively large in energy consumption of the base station. A physical channel and a physical signal transmitted by the base station a DL are as below.

Physical downlink shared channel (PDSCH): is a DL data channel including data to be transmitted to one or more UEs.

Physical downlink control channel (PDCCH): is a DL control channel including scheduling information about a PDSCH and a PUSCH. Alternatively, a PDCCH may solely transmit control information such as a slot format, a power control command, etc., without a PDSCH or a PUSCH for scheduling. The scheduling information includes resource information on which a PDSCH or a PUSCH is mapped, HARQ-associated information, power control information, etc.

Physical broadcast channel (PBCH): is a DL broadcast channel providing a master information block (MIB) that is essential system information needed for a UE to transmit and receive a data channel and a control channel.

Primary synchronization signal (PSS): is a signal used as a reference for DL time/frequency synchronization and provides partial information of a cell ID.

Secondary synchronization signal (SSS): is a signal used as a reference for DL time and/or frequency (hereinafter, time/frequency) synchronization and provides other partial information of the cell ID.

Demodulation reference signal (DM-RS): is a reference signal for the UE to estimate a channel for each of a PDSCH, a PDCCH, and a PBCH.

Channel-state information reference signal (CSI-RS): is a DL signal for reference when the UE measures a DL channel state.

Phase-tracking reference signal (PT-RS): is a DL signal for phase tracking.

In terms of base station energy saving, when the base station stops a DL transmission operation, an operation of a PA also stops in response thereto, such that a BS energy saving effect increases. Not only the PA, but also operations of other BS devices such as a baseband device decrease, and thus additional energy saving is possible. Similarly, even if a part of the uplink reception operation is relatively small in entire energy consumption of the base station, an additional energy saving effect may be obtained if an uplink reception operation can be stopped.

A DL transmission operation of the base station is basically dependent on the amount of DL traffic. For example, when the base station does not have data to be transmitted to a UE, there is no need for the base station to transmit a PDCCH for scheduling a PDSCH or a PDSCH. Alternatively, if the data can be temporarily suspended from transmission as the data is not sensitive to a transmission delay, the base station may refrain from transmitting a PDSCH and/or a PDCCH. Hereinafter, for convenience of description, a method for reducing base station energy consumption by refrain from transmitting a PDSCH and/or a PDCCH associated with data traffic or appropriately adjusting the same is called “base station energy saving method 1-1”.

On the contrary, physical channels and physical signals which include PSS, SSS, PBCH, CSI-RS, etc., are characterized in that they are repeatedly transmitted based on preset defined periodicity, regardless of data transmission to the UE. Therefore, even when the UE does not receive data, the UE may continuously update DL time/frequency synchronization, a DL channel state, a radio link quality, etc. That is, the PSS, SSS, PBCH, and CSI-RS have to be transmitted via a DL, regardless of DL data traffic, and thus causes energy consumption by the base station. Therefore, by adjusting transmission of the signals not related (or of low relativity) to data traffic to less frequently occur, base station energy saving may be achieved (hereinafter, referred to as “base station energy saving method 1-2”).

While the base station does not perform DL transmission via “base station energy saving method 1-1” or “base station energy saving method 1-2” above, an operation of PAs of the base station, an operation of a radio frequency (RF) device related thereto, an operation of a baseband device, etc., may be stopped or minimized such that an energy saving effect of the base station can be maximized.

As another method, by switching off some of antennas or the PAs of the base station, energy consumption of the base station can be saved (hereinafter, “base station energy saving method 2”). In this case, as a reaction to the energy saving effect of the base station, a decrease in cell coverage or a decrease in throughput may be caused. For example, when the base station, which has 64 transmission antennas and 64 PAs corresponding thereto in a frequency band of 3.5 GHz and operates in a bandwidth of 100 MHz, activates only four transmission antennas and four PAS during a preconfigured time period so as to reduce base station energy consumption and switches off the others, base station energy consumption during the time period may be reduced by about 1/16 (= 4/64). However, due to a decrease in maximum transmission power and a decrease in a beamforming gain, it is difficult to achieve cell coverage and throughput of 64 antennas and 64 PAs.

Hereinafter, to distinguish from a normal base station operation, a base station mode in which an operation for base station energy saving is applied is called an energy saving mode (ES mode), and a base station mode to which a normal base station operation is applied is called a base station normal mode.

As another method for supporting data services at ultra-high speeds, in a 5G system, signal transmission and reception over ultrawide bandwidths of several tens to several hundreds of MHz or several GHz may be supported. The signal transmission and reception over the ultrawide bandwidths may be supported through a single component carrier (CC) or a carrier aggregation (CA) technology that combines multiple CCs. In a case where a mobile operator fails to acquire a sufficiently high bandwidth frequency to provide ultra-high-speed data services with a single CC, a CA technology may combine individual component carriers having relatively small bandwidths to increase a total frequency bandwidth, thereby consequently enabling ultra-high-speed data services.

As described above, the frequency band utilized in the 5G system is wide from several hundreds of MHz to several tens of GHz.

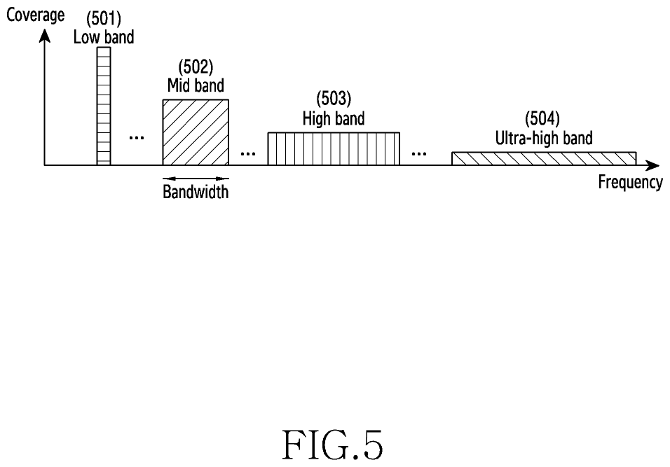

FIG. 5 illustrates a correlation between a frequency band, a coverage, and a bandwidth.

In general, as the frequency band is low, coverage gets wider due to a relatively small pathloss, and as the frequency band is high, coverage gets narrower due to a relatively large pathloss. In the low-frequency band, the frequency which can be utilized for mobile communication is relatively less and the bandwidth is small, whereas the high-frequency band is suitable for an ultra-high speed data service since securing wideband frequency is relatively easy. As the mobile communication system evolves, efforts to discover and utilize a new frequency band have been made. For example, it is in the initial discussion stage yet, but a terahertz (THz) (1012 Hz) band is considered as one of candidate frequencies in a 6th generation (6G) mobile communication system corresponding to the next-generation mobile communication system. In general, a mobile communication operator provides a user with a mobile communication service by securing several frequency bands. For example, the mobile communication operator may combine the already secured LTE system frequency band and a newly secured 5G system frequency to operate a system by combining LTE and 5G. In another example, the mobile communication operator may secure the 5G system frequency band over several bands, and then combine the frequencies of several bands to provide the mobile communication system through 5G CA. As described above, the characteristics of the coverage, bandwidth, etc. vary according to the frequency band, a mobile communication service combining several frequency bands is more actively provided compared to a mobile communication system dependent on a single frequency band.

Hereinafter, a system operation proposed in the disclosure through a detailed embodiment is described.

### First Embodiment

The first embodiment illustrates a communication system structure obtained by combining frequencies of several bands to reinforce the frequency use efficiency. The frequencies may be directly adjacent to or apart from each other in the frequency domain.

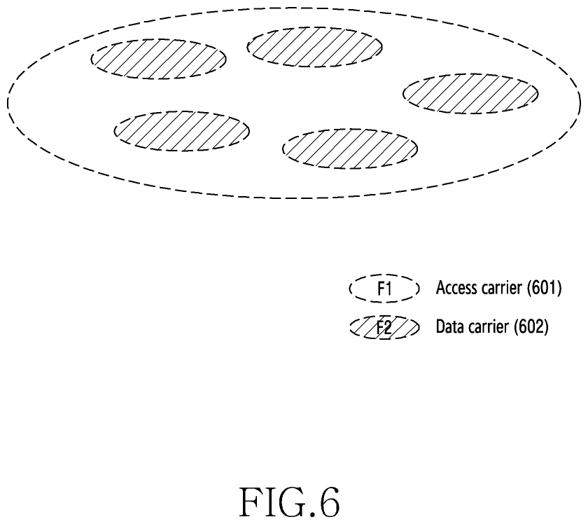

FIG. 6 illustrates an example of a communication system including an access carrier and a data carrier.

Hereinafter, a main concept of the first embodiment is described with reference to FIG. 6. The communication system of FIG. 6 includes a carrier (hereinafter, referred to as an “access carrier” 601 for convenience of description) operating in frequency F1 and a carrier (hereinafter, referred to as a “data carrier” 602) operating in frequency F2 (F1<F2). Since F1 has a relatively low frequency band, there is an advantage in the coverage, but there is limitation to providing a high-speed data service due to the restriction of the bandwidth. Since F2 has a relatively high frequency band, there is a disadvantage relatively in the coverage, but there is an advantage in providing high-speed data service since F2 has a relatively wide bandwidth. The size of the circle shown in FIG. 6 indicates the size of coverage which can be provided by each carrier. The example of FIG. 6 shows that multiple data carriers coexist within the coverage of an access carrier. The access carrier and the data carries are wiredly or wirelessly connected to each other and can cooperate with each other seamlessly. A base station and a UE to which the first embodiment is applied support an operation in F1 and F2. Accordingly, through the first embodiment, the coverage and high-speed data service can be provided according to a situation. The base station in the disclosure may have a form obtained by combining the access carrier and the data carrier, or the access carrier and the data carrier may be separately implemented as base stations, respectively. When the access carrier and the data carrier is implemented as a single base station, the access carrier and the data carrier may be referred to as transmission reception points (TRPs) using different frequencies from each other. The access carrier may be implemented as a base station for transmitting a signal through a frequency resource corresponding to the access carrier. The data carrier may be implemented as a base station for transmitting a signal through a frequency resource corresponding to the data carrier.

The access carrier provides essential information of a communication system such as the above-described synchronization signal, PBCH, system information, etc., and maintains a switch-on state to support all UEs in the system regardless of the state of the UE. The base station in the switch-on state maintains the power of a transmission block and a reception block to be turned on, and performs a common transmission and reception operation. The UE performs an initial access operation through the access carrier. The data carrier switches between a switch-on state and a switch-off state as necessary. In the switch-off state, the power of the base station is remained to be partly or all turned off. Normally, the data carrier is switched on to service the connected-UE having completed the initial access, and if there is no more UE to be serviced, the data carrier is switched off to save unnecessary base station energy consumption. Unlike the access carrier, the data carrier may increase the frequency efficiency by omitting or minimizing transmission of essential information provided to the UE.

The first embodiment may be classified into the following scenarios according to whether it is in the initial access stage and described. The state of the UE may be largely classified into a connected state (e.g., RRC_CONNECTED state) and an idle state (e.g., RRC_IDLE state). When the UE is turned on, the UE goes through a series of initial access procedures such as performing time and frequency synchronization with the base station as a preparation stage for performing data communication with the base station, acquiring system information from the base station, and performing a random access procedure. The state of the UE in the initial access stage is called an idle state. Once the initial access stage is completed, the UE switches to the connected state and can perform data transmission and reception with the base station one on one.

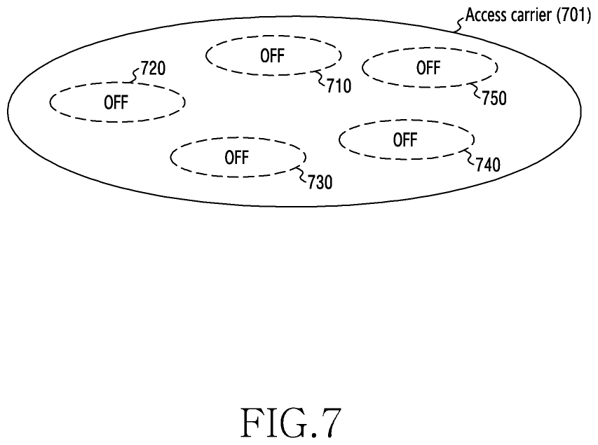

FIG. 7 illustrates an example of an operation scenario of a communication system including an access carrier and a data carrier.

Scenario 1-1: A scenario in which the UE performs initial access with the base station

FIG. 7 illustrates a system including an access carrier 701 and data carriers 710, 720, 730, 740, and 750. As a case where there is no UE in the connected state within the current system, the access carrier maintains the switch-on state to support all UEs in the system regardless of the state of the UE, as described above. On the contrary, the data carrier maintains the switch-off state so that a base station energy saving effect can be expected. The UE in the idle state acquires the synchronization signal, system information, etc. from the access carrier, and performs, based thereon, a random access procedure with the access carrier.

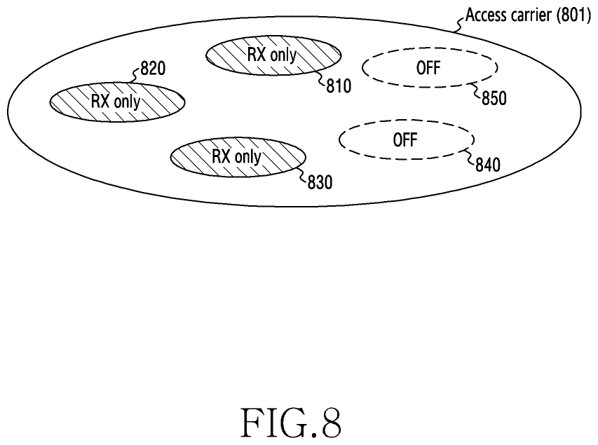

FIG. 8 illustrates an example of an operation scenario of a communication system including an access carrier and a data carrier.

Scenario 1-2: Another scenario in which the UE performs initial access with the base station

FIG. 8 illustrates a system including an access carrier 801 and data carriers 810, 820, 830, 840, and 850. As a case where there is no UE in the connected state within the current system, and the access carrier maintains the switch-on state to support all UEs in the system regardless of the state of the UE, as described above. In the case of FIG. 8, some (840 and 850, hereinafter, referred to as “data carrier set #1”) of the data carriers maintain the switch-off state in both transmission and reception operations so that a base station energy saving effect can be expected. The others (810, 820, and 830, referred to as “data carrier set #2”) of the data carriers switch off the transmission operation and switch on the reception operation so that a partial base station energy saving effect can be expected. Similar to scenario 1-1 above, the UE in the idle state acquires the synchronization signal, system information, etc. from the access carrier, and performs a random access procedure based thereon. However, unlike scenario 1-1 above, the random access procedure may be performed for the access carrier or the data carrier set #2. An uplink signal transmitted by the UE during the random access procedure may be received by the access carrier or the data carrier set #2.

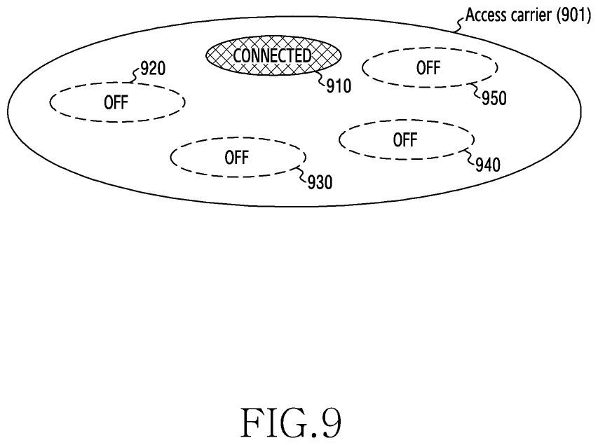

FIG. 9 illustrates an example of an operation scenario of a communication system including an access carrier and a data carrier.

Scenario 2: A scenario in which the UE and the base station performs communication

The UE having completed the initial access procedure may perform one-one-one data communication with the data carrier. FIG. 9 illustrates a case where a data carrier 910 is currently determined as the most suitable base station to service the UE in the connected state, and the data carrier 910 is switched to the switch-on state and performs one-one-one data communication with the UE. The grounds for determining whether to switch on a predetermined data carrier may include whether a channel quality state between the UE and the corresponding data carrier exceeds predetermined threshold A, whether the service corresponds to a high-speed data service in which a data rate required by the UE exceeds predetermined threshold B, etc. Control information related to threshold A and threshold B may be configured for the UE by the base station in advance via signaling. A data carrier having failed to satisfy the switch-on condition remains in the switch-off state to expect a base station energy saving effect. The access carrier may determine whether to switch on or switch off the data carrier, and notify the corresponding data carrier of a result of the determination via signaling. Scenario 2 may be changed several times in relation to the operation between the UE and the access carrier.

For example, as the first method, when the UE performs data communication with the data carrier that is in the switch-on state, the UE no longer performs data communication with the access carrier. That is, the UE performs data communication with one base station at a random moment. However, an operation such as receiving a synchronization signal and acquiring system information from the access carrier by the UE is still possible.

As the second method, even though the UE performs data communication with the data carrier that is in the switch-on state, the UE may perform data communication with the access carrier. That is, the UE may perform data communication with both the access carrier and the data carrier at a random moment. In this case, the UE performs relatively high-speed data transmission and reception with the data carrier and performs relatively low-speed data transmission and reception with the access carrier.

### Second Embodiment

The second embodiment describes a random access procedure of the UE and the base station. The main gist of the second embodiment is as follows.

A random access preamble transmitted to the base station by the UE is divided into two stages and applied. In the first stage, the UE transmits a random access preamble to the access carrier, and the corresponding random access preamble includes information on the data carrier to which the terminal is to access in the next stage. In the second stage, the UE transmits a random access preamble to the data carrier, and performs an operation of perform time-frequency synchronization between the UE and the data carrier.

A correlation between the data carrier and the random access preamble transmitted by the UE in the first stage is applied. For example, when the UE transmits random access preamble #1, this may indicate that the UE is to access to data carrier #1. The correlation may be informed of by promising the same in advance between the UE and the base station or by configuring the same for the UE by the base station as system information.

The access carrier may acquire, from the random access preamble received from the UE, information on the data carrier to which the UE is to access, and with reference thereto, may determine the data carrier to be switched on and indicate the same to the corresponding data carrier via signaling.

The data carrier having switched to the switch-on state transmits a reference signal so that the UE may measure a channel quality state of the data carrier.

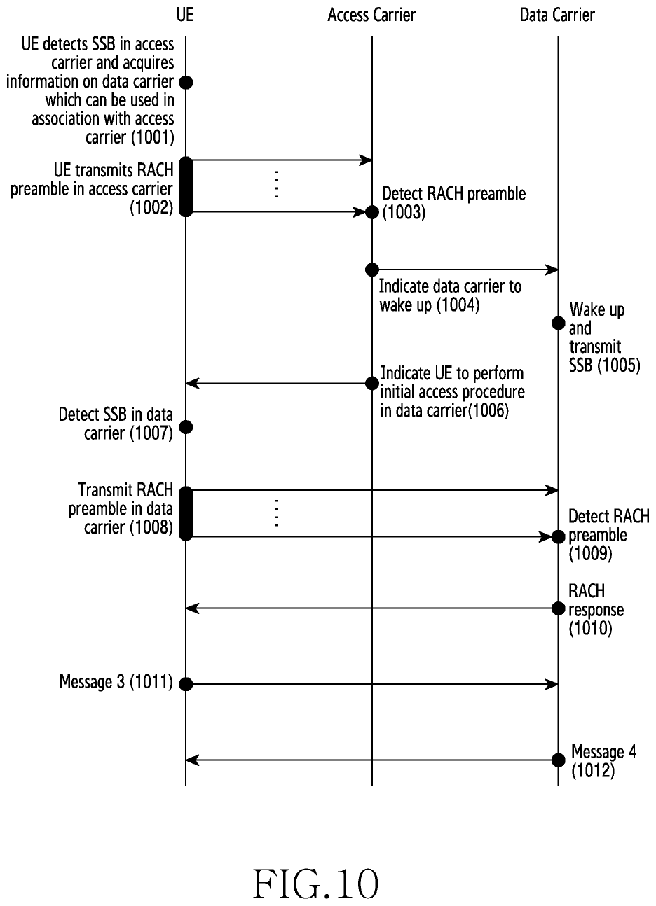

FIG. 10 illustrates an example of a random access procedure in a wireless communication system according to various embodiments of the disclosure.

Hereinafter, a random access procedure according to the second embodiment is described in detail with reference to FIG. 10.

In operation 1001, the UE receives a synchronization signal, a PBCH, system information, etc. from an access carrier to perform time-frequency synchronization with the access carrier and acquire information required for a random access procedure. In addition, in operation 1001, the UE acquires control information (hereinafter, referred to as “control information #1”) for one or more data carriers connected to the access carrier. The control information #1 may be included in the synchronization signal, PBCH, system information, etc. received from the access carrier by the UE, and transmitted. The control information #1 may include control information for a reference signal such as an SSB or a CSI-RS required to measure a channel quality state of the corresponding data carrier. In addition, the control information #1 may include frequency information of the data carrier connected to the access carrier.

In operation 1002, the UE starts a random access procedure by transmitting the random access preamble to the access carrier, based on the information acquired in operation 1001. In this case, the initial transmission power and transmission beam direction of the random access preamble may be determined according to the synchronization signal of the access carrier measured by the UE in operation 1001. When the UE fails to receive a response to the random access preamble transmission from the base station, the UE may transmit the random access preamble again. In operation 1002, the random access preamble transmitted by the UE may explicitly or implicitly include information on the data carrier preferred by the UE. For example, the UE may select a data carrier having the best channel quality state from among several data carriers, and notify the access carrier of the selected data carrier.

In operation 1003, the access carrier successfully detects the random access preamble transmitted by the UE. Accordingly, the access carrier also acquires information on the data carrier preferred by the UE, and determines a data carrier to be switched to the switch-on state (or to be woken up) with reference thereto.

In operation 1004, the access carrier indicates, to the data carrier to be switched on, to switch to the switch-on state via signaling. In addition, the data carrier may respond to the access carrier that the indication has been successfully received.

In operation 1005, the data carrier switches to the switch-on state and initiates reference signal transmission according to the indication of the access carrier. The reference signal may be the SSB, CRI-RS, etc.

In operation 1006, the access carrier indicates, to the UE, to perform a procedure of random access to the data carrier.

In operation 1007, the UE successfully detects a reference signal transmitted by the data carrier. Accordingly, the UE may perform time-frequency synchronization with the data carrier.

In operation 1008, the UE starts the random access procedure by transmitting the random access preamble to the data carrier. In this case, the initial transmission and transmission beam direction of the random access preamble may be determined according to the reference signal of the data carrier measured by the UE in operation 1007.

When the data carrier successfully detects the random access preamble transmitted by the UE in operation 1009, the data carrier transmits a random access response signal to the UE in operation 1010.

In operation 1011, the UE transmits message 3 on the random access procedure to the data carrier, and in response thereto, the data carrier completes the random access procedure by transmitting message 4 to the UE in operation 1012. Thereafter, the UE may perform one-on-one data communication with the data carrier.

In operation 1009, when the data carrier fails to perform random access preamble detection, the UE may restart from operation 1002 or restart from operation 1008. In this case, an operation from which the UE restarts may be indicated to the UE by the data carrier, or the operation may be performed according to a determination by the UE itself.

The second embodiment may have various alternations. For example, the signal transmitted to the UE by the access carrier in operation 1006 may be substituted with a response signal to the random access preamble transmitted to the access carrier by the UE in operation 1002. Additionally, after operation 1006, the random access procedure between the UE and the access carrier may be completed by performing transmission and reception of message 3 and message 4 between the UE and the access carrier.

### Third Embodiment

The third embodiment describes a random access procedure of the UE and the base station in a method different from the second embodiment. The third embodiment basically follows the second embodiment, but has following additional characteristics. The third embodiment operates by including an access and mobility management function (AMF) corresponding to a network entity for performing a function such as UE authentication, security, and mobility management in the system. The AMF determines, with reference to the information provided from the access carrier, a data carrier to be switched to the switch-on state, and indicates, to the corresponding data carrier, to switch on via signaling.

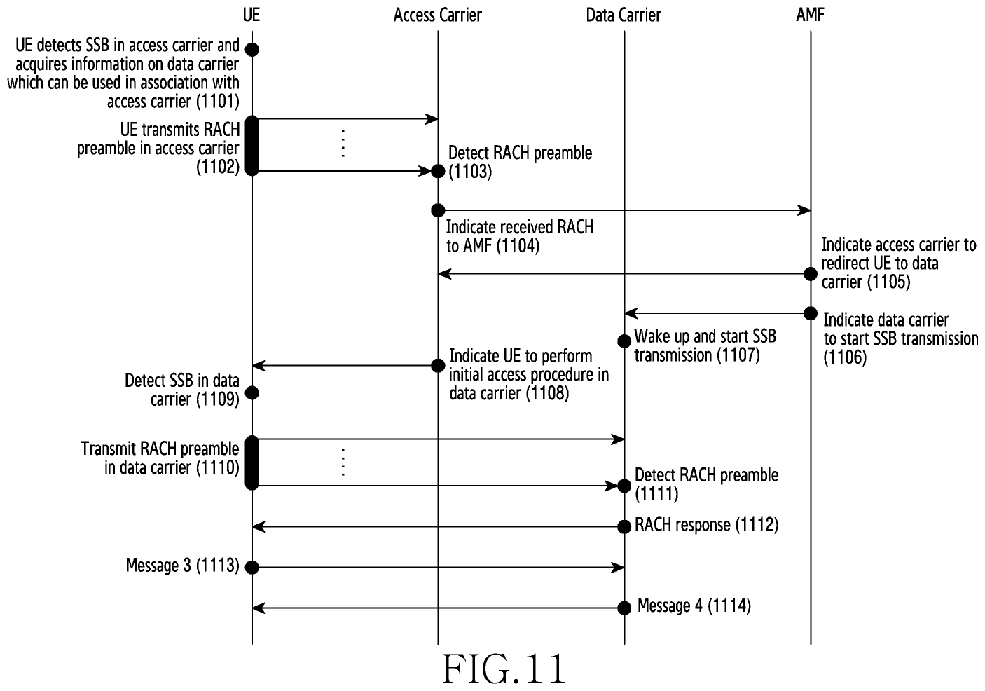

FIG. 11 illustrates an example of a random access procedure in a wireless communication system according to various embodiments of the disclosure.

Hereinafter, a random access procedure according to the third embodiment is described in detail with reference to FIG. 11.

In operation 1101, the UE receives a synchronization signal, a PBCH, system information, etc. from an access carrier to perform time-frequency synchronization with the access carrier and acquire information required for a random access procedure. In addition, in operation 1101, the UE acquires control information (hereinafter, referred to as “control information #1”) for one or more data carriers connected to the access carrier. The control information #1 may be included in the synchronization signal, PBCH, system information, etc. received from the access carrier by the UE, and transmitted. The control information #1 may include control information for a reference signal such as an SSB or a CSI-RS required to measure a channel quality state of the corresponding data carrier. In addition, the control information #1 may include frequency information of the data carrier connected to the access carrier.

In operation 1102, the UE starts a random access procedure by transmitting the random access preamble to the access carrier, based on the information acquired in operation 1101. In this case, the initial transmission power and transmission beam direction of the random access preamble may be determined according to the synchronization signal of the access carrier measured by the UE in operation 1101. When the UE fails to receive a response to the random access preamble transmission from the base station, the UE may transmit the random access preamble again. In operation 1102, the random access preamble transmitted by the UE may explicitly or implicitly include information on the data carrier preferred by the UE. For example, the UE may select a data carrier having the best channel quality state from among several data carriers, and notify the access carrier of the selected data carrier.

In operation 1103, the access carrier successfully detects the random access preamble transmitted by the UE. Accordingly, the access carrier also acquires information on the data carrier preferred by the UE.

In operation 1104, the access carrier transfers, to an AMF, information on the data carrier preferred by the UE, the information being acquired from the UE.

In operation 1105, the AMF determines a data carrier to be switched to the switch-on state, and notify, to the access carrier, that the data carrier is to be managed by the UE.

In operation 1106, the AMF indicates, to the data carrier to be switched on, to switch the switch-on state via signaling. In addition, the data carrier may respond to the access carrier that the indication has been successfully received.

In operation 1107, the data carrier switches to the switch-on state and initiates reference signal transmission according to the indication of the AMF. The reference signal may be the SSB, CRI-RS, etc.

In operation 1108, the access carrier indicates, to the UE, to perform a procedure of random access to the data carrier.

In operation 1109, the UE successfully detects a reference signal transmitted by the data carrier. Accordingly, the UE may perform time-frequency synchronization with the data carrier.

In operation 1110, the UE starts the random access procedure by transmitting the random access preamble to the data carrier. In this case, the initial transmission and transmission beam direction of the random access preamble may be determined according to the reference signal of the data carrier measured by the UE in operation 1109.

When the data carrier successfully detects the random access preamble transmitted by the UE in operation 1111, the data carrier transmits a random access response signal to the UE in operation 1112.

In operation 1113, the UE transmits message 3 on the random access procedure to the data carrier, and in response thereto, the data carrier completes the random access procedure by transmitting message 4 to the UE in operation 1114. Thereafter, the UE may perform one-on-one data communication with the data carrier.

In operation 1111, when the data carrier fails to perform random access preamble detection, the UE may restart from operation 1102 or restart from operation 1110. In this case, an operation from which the UE restarts may be indicated to the UE by the data carrier, or the operation may be performed according to a determination by the UE itself.

The third embodiment may have various alternations. For example, the signal transmitted to the UE by the access carrier in operation 1108 may be substituted with a response signal to the random access preamble transmitted to the access carrier by the UE in operation 1102. Additionally, after operation 1108, the random access procedure between the UE and the access carrier may be completed by performing transmission and reception of message 3 and message 4 between the UE and the access carrier.

### Fourth Embodiment

The fourth embodiment describes a random access procedure of the UE and the base station in a method different from the second and third embodiments. The fourth embodiment has the following additional characteristics, compared to the second and third embodiments. The fourth embodiment operates in a 2-stage procedure when the data carrier is switched to the switch-on state according to the indication of the AMF. In the first stage, the data carrier switches only a reception function to a switch-on state while maintaining a transmission function as a switch-off state. In the second stage, when the data carrier successfully detects the random access preamble from the UE, the data carrier initiates reference signal transmission after additionally switching the transmission function to the switch-on state.

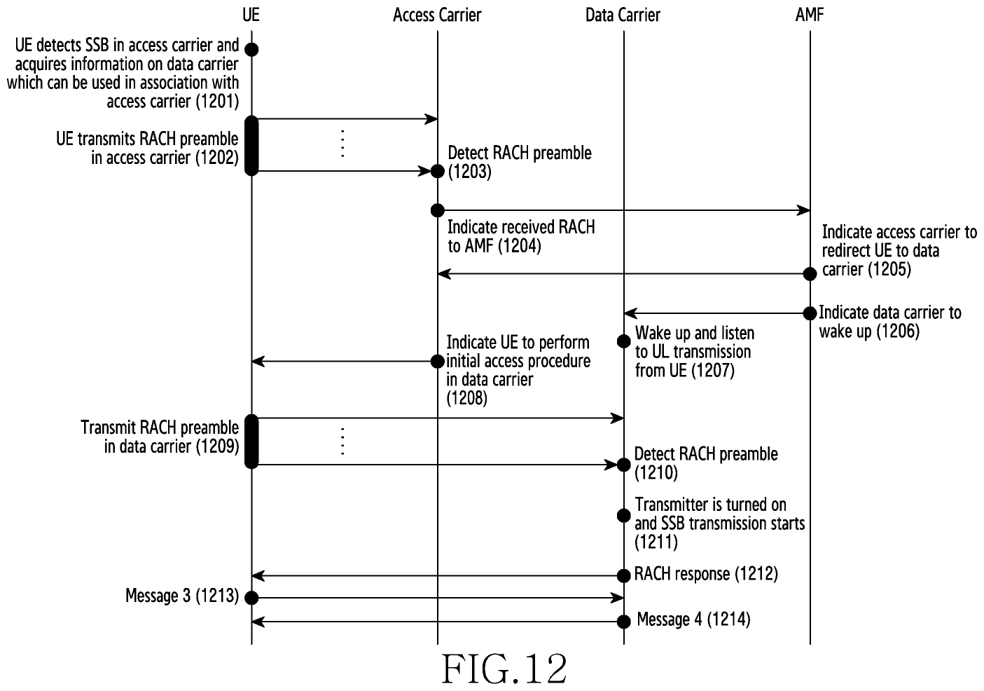

FIG. 12 illustrates an example of a random access procedure in a wireless communication system according to various embodiments of the disclosure.

Hereinafter, a random access procedure according to the fourth embodiment is described in detail with reference to FIG. 12.

In operation 1201, a UE receives a synchronization signal, a PBCH, system information, etc. from an access carrier to perform time-frequency synchronization with the access carrier and acquire information required for a random access procedure. In addition, in operation 1201, the UE acquires control information (hereinafter, referred to as “control information #1”) for one or more data carriers connected to the access carrier. The control information #1 may be included in the synchronization signal, PBCH, system information, etc. received from the access carrier by the UE, and transmitted. The control information #1 may include control information for a reference signal such as an SSB or a CSI-RS required to measure a channel quality state of the corresponding data carrier. In addition, the control information #1 may include frequency information of the data carrier connected to the access carrier.

In operation 1202, the UE starts a random access procedure by transmitting the random access preamble to the access carrier, based on the information acquired in operation 1201. In this case, the initial transmission power and transmission beam direction of the random access preamble may be determined according to the synchronization signal of the access carrier measured by the UE in operation 1201. When the UE fails to receive a response to the random access preamble transmission from the base station, the UE may transmit the random access preamble again. In operation 1202, the random access preamble transmitted by the UE may explicitly or implicitly include information on the data carrier preferred by the UE. For example, the UE may select a data carrier having the best channel quality state from among several data carriers, and notify the access carrier of the selected data carrier.

In operation 1203, the access carrier successfully detects the random access preamble transmitted by the UE. Accordingly, the access carrier also acquires information on the data carrier preferred by the UE.

In operation 1204, the access carrier transfers, to an AMF, information on the data carrier preferred by the UE, the information being acquired from the UE.

In operation 1205, the AMF determines a data carrier to be switched to the switch-on state, and notify, to the access carrier, that the data carrier is to be managed by the UE.

In operation 1206, the AMF indicates, to the data carrier to be switched on, to switch a reception function to the switch-on state via signaling. In addition, the data carrier may respond to the access carrier that the indication has been successfully received.

In operation 1207, the data carrier switches the reception function to the switch-on state according to the indication of the AMF, and attempts detection of the random access preamble of the UE.

In operation 1208, the access carrier indicates, to the UE, to perform the random access procedure to the data carrier. In this case, the access carrier may inform the UE of the initial transmission power and transmission beam direction of the random access preamble.

In operation 1209, the UE starts the random access procedure by transmitting the random access preamble to the data carrier.

When the data carrier successfully detects the random access preamble transmitted by the UE in operation 1210, the data carrier switches on a transmission function and transmits a reference signal in operation 1211. The reference signal may be an SSB or a CSI-RS. The UE may perform time-frequency synchronization with the data carrier from the reference signal transmitted by the data carrier.

In operation 1212, the data carrier transmits a random access response signal to the UE.

In operation 1213, the UE transmits message 3 on the random access procedure to the data carrier, and in response thereto, the data carrier completes the random access procedure by transmitting message 4 to the UE in operation 1214. Thereafter, the UE may perform one-on-one data communication with the data carrier

Successful random access preamble detection of the data carrier in operation 1210 is a precondition for fully switching the data carrier to the switch-on state. When the data carrier fails to perform random access preamble detection in operation 1210, the UE may restart from operation 1202 or restart from operation 1209. In this case, an operation from which the UE restarts may be indicated to the UE by the data carrier, or the operation may be performed according to a determination by the UE itself.

The fourth embodiment may have various alternations. For example, the signal transmitted to the UE by the access carrier in operation 1208 may be substituted with a response signal to the random access preamble transmitted to the access carrier by the UE in operation 1202. Additionally, after operation 1208, the random access procedure between the UE and the access carrier may be completed by performing transmission and reception of message 3 and message 4 between the UE and the access carrier.

### Fifth Embodiment

The fifth embodiment describes a detailed method of making a correlation between a random access preamble and a data carrier as described in the above-described embodiments.

As described above, in the initial access stage, the UE may inform the base station of a data carrier which has a superior channel quality state with the UE and is suitable to be switched to the switch-on state, via random access preamble transmission. In general, the channel quality state between the UE and the base station is affected by the distance between the UE and the base station, whether there is an obstacle between the UE and the base station, etc. That is, location information of the UE in a cell is a main factor for determining the channel quality state between the UE and the data carrier. If the UE or the base station wrongly determines the data carrier to be switched on, an unsuitable data carrier is switched on, which may cause unnecessary base station energy consumption and cause bad influence to a data rate providable to the UE. The base station may identify, with respect to the UE in the connected state, UE location information at a predetermined level or higher accuracy through the process of UE location measurement of the base station, UE location measurement and report of the UE, etc. On the contrary, the UE in the initial access stage is in the stage before being registered in the network yet, and thus it is difficult to identify the location of the UE by the base station. The fifth embodiment defines a correlation between the random access preamble and the data carrier, which supports that the data carrier can be switched to the switch-on state, by identifying, by the UE, its location information in the initial access and providing information relating thereto to the base station.

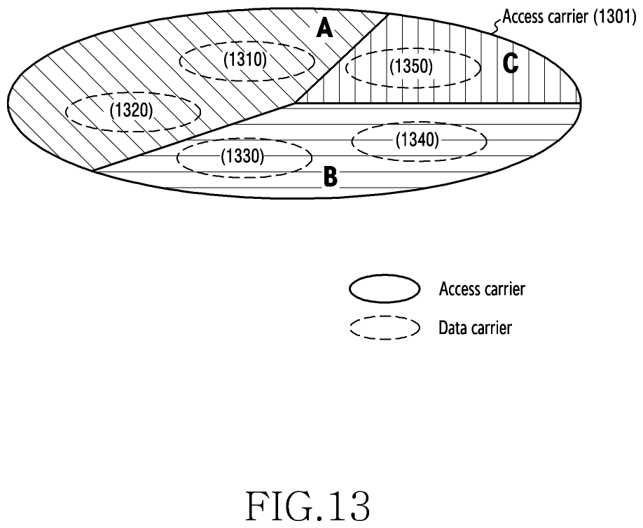

Hereinafter, a correlation between a random access preamble and a data carrier is described with reference to FIGS. 13, 14, and 15.

FIG. 13 illustrates an example of a correlation between a random access preamble and a data carrier.

FIG. 13 assumes a case where five data carriers are included in coverage of an access carrier. FIG. illustrates a case where coverage of the access carrier is divided into regions including region A, region B, and region C according to the location of the UE. The UE identifies a region in the coverage of the access carrier, in which the UE itself is located, and then initiates a random access procedure by using a random access preamble connected to the corresponding region. The access carrier determines, from the random access preamble detected from the UE, a data carrier to be switched on. For example, the correlation as in expression 2 among a location (region) in a cell of the UE, a random access preamble group, and a data carrier is promised in advance between the UE and the base station. The base station may notify the UE of the correlation through system information, or define the same as a predetermined rule. The random access preamble group indicates a group including at least one or more random access preambles.

Region A→Random access preamble group A→Data carrier A

Region B→Random access preamble group B→Data carrier B

Region C→Random access preamble group C→Data carrier C

. . . Expression 2

In the example of FIG. 13, when the UE is located in region C, the UE initiates a random access procedure by using a random access preamble in random access preamble group C. When the access carrier successfully detects the random access preamble transmitted by the UE, a data carrier 1350 connected to the corresponding region or random access preamble group is determined to be switched to the switch-on state.

To identify its location, the UE measures an SSB transmitted by the access carrier. As described in FIG. 2, when receiving the SSB, the UE may identify an SSB index. From the characteristics of the beam-swept SSB, a relationship between the SSB index and the UE location may be approximately mapped. For example, in a case of FIG. 13, SSB #0 and SSB #1 may be mapped to region A, SSB #2 and SSB #3 may be mapped to region B, and SSB #4 and SSB #5 may be mapped to region C. Accordingly, for example, when the UE has measured that a reception signal quality of SSB #4 is the most superior, the UE may determine that the UE itself is located in region C mapped to SSB #4.

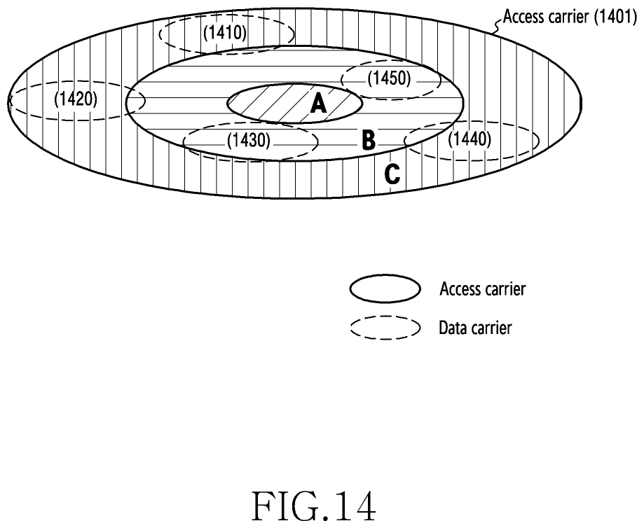

FIG. 14 illustrates an example of a correlation between a random access preamble and a data carrier.

Similar to FIG. 13, FIG. 14 illustrates a case where five data carriers are included in coverage of an access carrier, and the coverage of the access carrier is divided into three regions including region A, region B, and region C according to the cell center and the location of the UE. The UE may identify the location of the UE itself by measurement the strength of a reception signal of the SSB received from the access carrier. For example, a relationship between the UE location and the reception signal strength of the SSB as in Expression 3 below.

Reception signal strength≥Threshold 1→Region A

Threshold 2≤Reception signal strength<Threshold 1→Region B

Threshold 3≤Reception signal strength<Threshold 2→Region C

. . . Expression 3

The expression above shows a case where threshold 1>threshold 2>threshold 3, the closer to the central region of the access carrier, the larger the SSB reception signal strength, and the farther from the center of the access carrier, the smaller the SSB reception signal strength. The base station may inform the UE of threshold 1, threshold 2, and threshold 3 through system information. In the example of FIG. 14, when the UE determines that the UE is in region B according to <Expression 3> from the reception signal strength of the SSB measured by the UE, the UE initiates a random access procedure by using a random access preamble of random access preamble group B correlated to region B according to <Expression 2>. When the access carrier successfully detects the random access preamble transmitted by the UE, a data carrier 1430 or 1450 correlated to the corresponding region or random access preamble group is determined to be switched to the switch-on state.

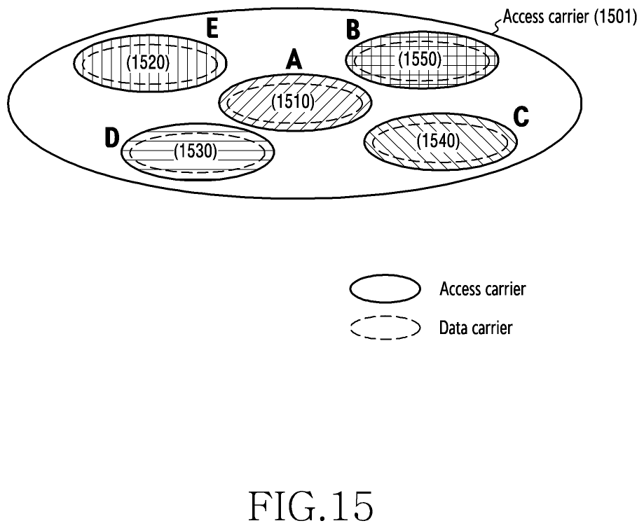

FIG. 15 illustrates a correlation between a random access preamble and a data carrier.

FIG. 15 illustrates a case where five data carriers are included in coverage of an access carrier, and the coverage of the access carrier is divided into five regions including region A, region B, region C, region D, and region E according to the location of the UE. In determining the location of the UE, there is restriction in the case of the method of FIG. 13 in that the direction from the center of the access carrier to the UE may be determined, and there is restriction in the case of the method of FIG. 14 in that the distance from the center of the access to the UE may be determined. In FIG. 15, in combination of the method of FIG. 13 and the method of FIG. 14, the UE location may be determined in consideration of both the direction and the distance. For example, in the case of FIG. 15, it is difficult to distinguish, using only the reception signal strength of the SSB received by the UE, between region B, region C, region D, and region E located near from the center of the cell of the access carrier. Accordingly, additionally, the UE may determine the direction from the center of the cell of the access carrier by utilizing the SSB index acquired by the UE, and specify the location of the UE itself. For example, the SSB index acquired by the UE may indicate that the direction of the UE from the center of the cell of the access carrier is region group #1={region A or region E}. In addition, the UE may determine, from the reception signal strength of the SSB received by the UE, that the distance from the center of the cell is region group #2={region B, region C, region D, and region E}. Accordingly, the UE may finally determine region E belonging to a common region of region group #1 and region group #2 as the location of the UE itself. Thereafter, the UE initiates a random access procedure by transmitting a random access preamble belonging to a random access preamble group correlated to region E according to the rule of <Expression 2>. In this case, when the access carrier successfully detects the random access preamble transmitted by the UE, a data carrier 1520 correlated to the corresponding region or random access preamble group may be determined to be switched to the switch-on state.

In the fifth embodiment, the location measurement determination criterion for the UE is described with reference to the SSB transmitted by the access carrier, but the disclosure is not necessarily limited thereto. The UE may measure a CSI-RS providing a similar function to the SSB, or other reference signals to measure its location. Alternatively, the UE may separately have an independent location measurement function to measure its location.

In the fifth embodiment, the method for providing location information of the UE to the base station from the random access preamble transmitted by the UE as in Expression 2 is described, but the disclosure is not limited thereto. For example, the UE may include, in message 3 transmitted to the base station, information related to the location of the UE or information related to the data carrier preferred by the UE, during the random access process, and inform the same.

In the fifth embodiment, the random access preamble and the data carrier are correlated according to the location of the UE, but the disclosure is not limited thereto, and the correlation may be defined through various methods. For example, the size of uplink data to be transmitted by the UE may be restricted to be smaller when the location of the UE gets farther from the center of the cell, and a correlation between the random access preamble, the data size, and the data carrier may be defined.

### Sixth Embodiment

The sixth embodiment describes an example of a UE procedure and a base station procedure according to a preferred embodiment of the disclosure. The UE procedure and the base station procedure of the sixth embodiment may be combined with at least one embodiment among the first embodiment to the fifth embodiment and performed.

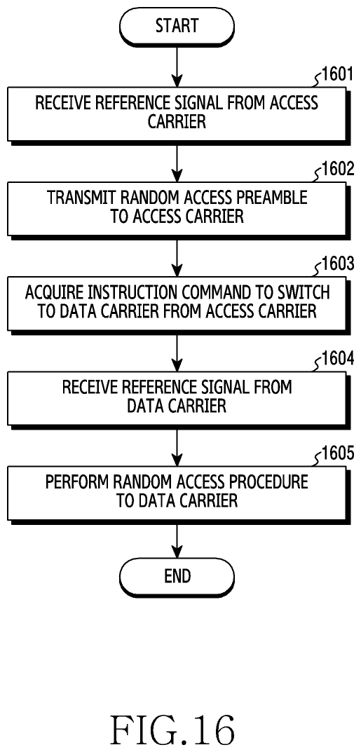

FIG. 16 illustrates an example of a UE procedure in a wireless communication system according to various embodiments of the disclosure.

FIG. 16 illustrates an example of a procedure of a UE to which a case where a base station operates by combining an access carrier and a data carrier is applied according to an embodiment of the disclosure.

In operation 1601, the UE receives a reference signal from an access carrier. The reference signal includes an SSB, a CSI-RS, etc. Additionally, the UE receives system information from the access carrier. The system information may include a correlation between the random access preamble and the data carrier.

Thereafter, in operation 1602, the UE transmits a random access preamble to the access carrier. The random access preamble may include information on a data carrier preferred by the UE.

In operation 1603, the UE receives an indication to perform the random access procedure from the access carrier to the data carrier.

In operation 1604, the UE receives the reference signal from the data carrier.

In operation 1605, the UE performs the random access procedure to the data carrier. When the random access procedure is successfully completed, the UE may perform one-on-one data communication with the data carrier in the subsequent operations.

The operations described above may be changed, omitted, or have different orders, or an undescribed operation may be added so that the disclosure can be performed. For example, the UE following the fourth embodiment may apply the same by switching operation 1604 and operation 1605.

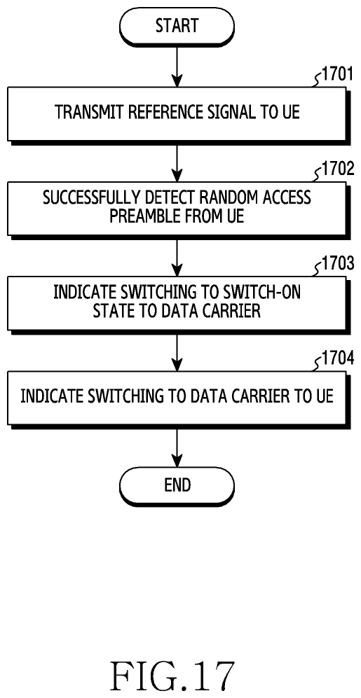

FIG. 17 illustrates an example of an access carrier procedure in a wireless communication system according to various embodiments of the disclosure.

FIG. 17 illustrates an example of a procedure of an access carrier to which a case of operating by combining an access carrier and a data carrier is applied according to an embodiment of the disclosure.

In operation 1701, an access carrier transmits a reference signal to a UE. Additionally, the access carrier may transmit, to the UE, system information including a correlation between the random access preamble and the data carrier.

In operation 1702, the access carrier successfully detects a random access preamble transmitted by the UE. The access carrier also acquires information on a data carrier preferred by the UE from the successfully detected random access preamble, and determines a data carrier to be switched to the switch-on state (or to be woken up) with reference thereto.

In operation 1703, the access carrier indicates, to the data carrier determined in operation 1702, to switch to the switch-on state via signaling.

In operation 1704, the access carrier indicates, to the UE, to perform the random access procedure to the data carrier.

The operations described above may be changed, omitted, or have different orders, or an undescribed operation may be added so that the disclosure can be performed. For example, in a case of a system following the third embodiment or the fourth embodiment, operation 1703 may be substituted by an operation in which the access carrier provides the AMF with data carrier information acquired from the UE, and receives a notification from the AMF that the data carrier is to manage the UE.

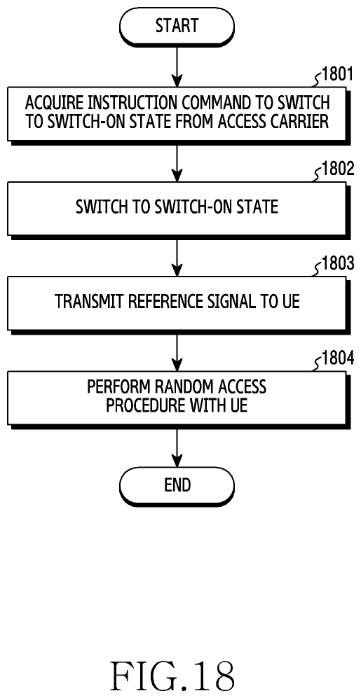

FIG. 18 illustrates an example of a data carrier procedure in a wireless communication system according to various embodiments of the disclosure.

FIG. 18 illustrates an example of a procedure of a data carrier to which a case of operating by combining an access carrier and a data carrier is applied according to an embodiment of the disclosure.

In operation 1801, a data carrier receives, from an access carrier, an indication indicating to switch to the switch-on state

In operation 1802, the data carrier switches to the switch-on state.

In operation 1803, the data carrier transmits a reference signal to the UE.

In operation 1804, the data carrier performs a random access procedure with the UE. When the random access procedure is successfully completed, the UE may perform one-on-one data communication with the data carrier in the subsequent operations.

The operations described above may be changed, omitted, or have different orders, or an undescribed operation may be added so that the disclosure can be performed. For example, in a case of a system following the third embodiment or the fourth embodiment, operation 1801 may be substituted by an operation in which the data carrier receives, from the AMF, an indication indicating to switch to the switch-on state.

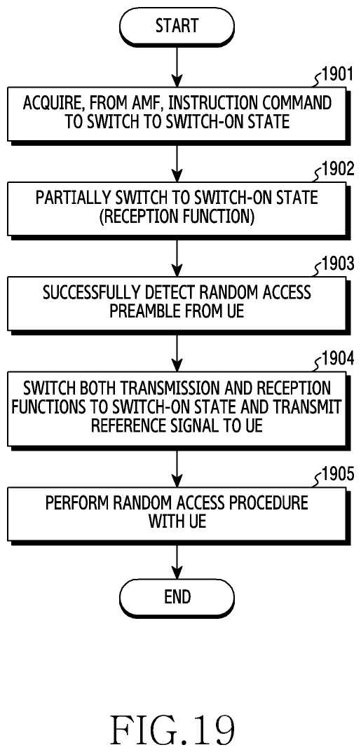

FIG. 19 illustrates an example of a data carrier procedure in a wireless communication system according to various embodiments of the disclosure.

FIG. 19 illustrates another example of a procedure of a data carrier to which a case of operating by combining an access carrier and a data carrier is applied according to an embodiment of the disclosure.

In operation 1901, a data carrier receives, from an AMF, an indication indicating to switch to the switch-on state

In operation 1902, the data carrier partially switches to the switch-on state. For example, only a reception function of the data carrier may be switched to the switch-on state.

In operation 1903, the data carrier successfully detects a random access preamble transmitted by the UE.

In operation 1904, the data carrier switches both a transmission function and a reception function to the switch-on state. In addition, the data carrier transmits a reference signal to the UE.

In operation 1905, the data carrier continues to perform the remaining random access procedure. When the random access procedure is successfully completed, the data carrier and the UE may perform one-on-one data communication in the subsequent operations.

The operations described above may be changed, omitted, or have different orders, or an undescribed operation may be added so that the disclosure can be performed.

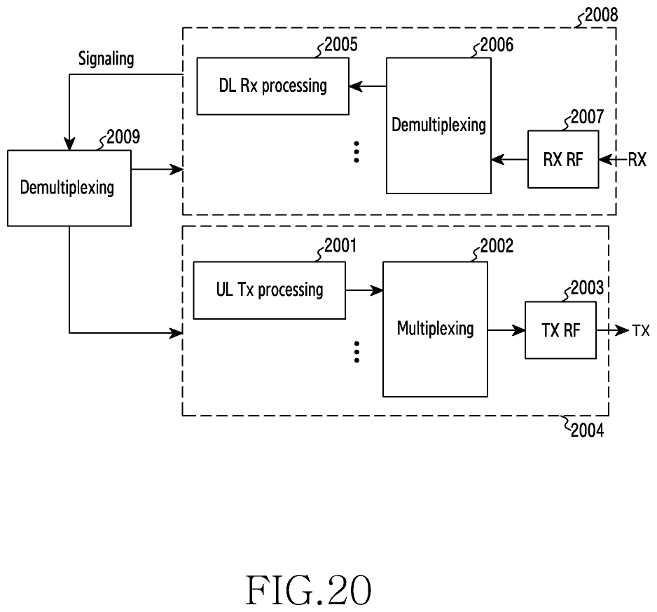

FIG. 20 illustrates UE transmission and reception devices in a wireless communication system according to various embodiments of the disclosure.

FIG. 20 illustrates an example of UE transmission and reception devices in a wireless communication system according to an embodiment of the disclosure. For convenience of description, the illustration and description of devices not directly related to the disclosure may be omitted.

Referring to FIG. 20, a UE may include a transmitter 2004 including an uplink transmission processing block 2001, a multiplexer 2002, and a transmission RF block 2003, a receiver 2008 including a downlink reception processing block 2005, a demultiplexer 2006, and a reception RF block 2007, and a controller 2009. The controller 2009 may control blocks of the receiver 2008 for receiving a data channel or a control channel transmitted by a base station as described above, and blocks of the transmitter 2004 for transmitting an uplink signal.

The uplink transmission processing block 2001 in the transmitter 2004 of the UE may generate a signal to be transmitted by performing processes such as channel coding and modulation. The signal generated by the uplink transmission processing block 2001 may be multiplexed with other uplink signals by the multiplexer 2002, undergo signal processing by the transmission RF block 2003, and then be transmitted to the base station.

The receiver 2008 of the UE may demultiplex a signal received from the base station and distribute the signal to respective downlink reception processing blocks. The downlink reception processing block 2005 may obtain control information or data transmitted by the base station by performing processes such as demodulation and channel decoding on a downlink signal of the BS. The receiver 2008 of the UE may support an operation of the controller 2009 by applying an output result of the downlink reception processing block to the controller 2009.

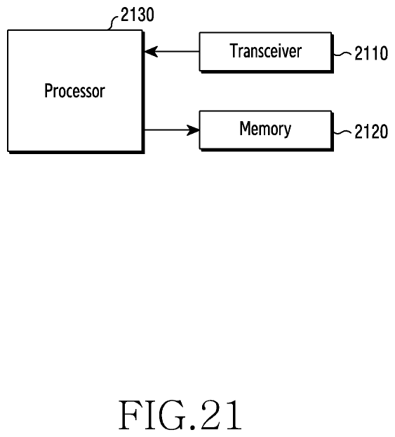

FIG. 21 illustrates an example of a configuration of a UE in a wireless communication system according to various embodiments of the disclosure.

As illustrated in FIG. 21, the UE of the disclosure may include a processor 2130, a transceiver 2110, and a memory 2120. However, elements of the UE are not limited to the above-described example. For example, the UE may include more or fewer elements than those described above. Furthermore, the processor 2130, the transceiver 2110, and the memory 2120 may be implemented as a single chip. According to an embodiment, the transceiver 2110 of FIG. 21 may include the transmitter 2004 and the receiver 2008 of FIG. 20. In addition, the processor 2130 of FIG. 21 may include the controller 2009 of FIG. 20.

According to an embodiment, the processor 2130 may control a series of processes such that the UE may operate according to an embodiment of the disclosure. For example, according to an embodiment of the disclosure, the processor may control the elements of the UE so that the UE performs transmission and reception methods by selecting one of an access carrier and a data carrier. The processor 2130 may include one or multiple processors, and perform the UE transmission and reception operation in the wireless communication system to which the operation of the disclosure is applied, by executing a program stored in the memory 2120.

The transceiver 2110 may transmit or receive a signal to or from the base station. The signal transmitted or received to or from the base station may include control information and data. The transceiver 2110 may include an RF transmitter for up-converting and amplifying a frequency of a signal to be transmitted, an RF receiver for low-noise amplifying a received signal and down-converting its frequency, etc. However, this is merely an example of the transceiver 2110, and elements of the transceiver 2110 are not limited to the RF transmitter and the RF receiver. Furthermore, the transceiver 2110 may receive a signal via a radio channel to output the signal to the processor 2130 and transmit a signal output from the processor 2130 via a radio channel.

According to an embodiment, the memory 2120 may store data and programs necessary for operations of the UE. Furthermore, the memory 2120 may store control information or data included in a signal transmitted or received by the UE. The memory 2120 may include storage media, such as ROM, RAM, hard discs, CD-ROM, and DVDs, or a combination thereof. In addition, the memory 2120 may include multiple memories. According to an embodiment, the memory 2120 may store a program for performing transmission and reception operations of the UE according to whether the UE is to communicate is an access carrier or a data carrier, which corresponds to the above-described embodiments of the disclosure.

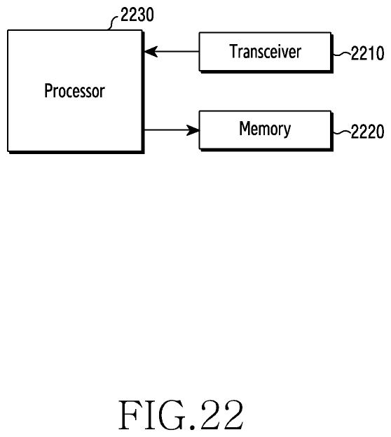

FIG. 22 illustrates an example of a configuration of a base station in a wireless communication system according to various embodiments of the disclosure.

As illustrated in FIG. 22, the base station of the disclosure may include a processor 2230, a transceiver 2210, and a memory 2220. However, elements of the base station are not limited to the above-described example. For example, the base station may include more or fewer elements than those described above. Furthermore, the processor 2230, the transceiver 2210, and the memory 2220 may be implemented as a single chip.

The processor 2230 may control a series of processes such that the base station may operate according to the above-described embodiments of the disclosure. For example, the processor may control the elements of the base station to perform a method of scheduling the UE according to whether an access carrier communicates with the UE or a data carrier communicates with the UE according to an embodiment of the present disclosure. The processor 2230 may include one or multiple processors, and perform the method of scheduling the UE according to whether the access carrier communicates with the UE or the data carrier communicates with the UE in the disclosure above, by executing a program stored in the memory 2220.

The transceiver 2210 may transmit or receive a signal to or from the UE. The signal transmitted or received to or from the UE may include control information and data. The transceiver 2210 may include an RF transmitter for up-converting and amplifying a frequency of a signal to be transmitted, an RF receiver for low-noise amplifying a received signal and down-converting its frequency, etc. However, this is merely an example of the transceiver 2210, and elements of the transceiver 2210 are not limited to the RF transmitter and the RF receiver. Furthermore, the transceiver 2210 may receive a signal via a radio channel to output the signal to the processor 2230, and transmit a signal output from the processor 2230 via a radio channel.

According to an embodiment, the memory 2220 may store data and programs necessary for operations of the base station. Furthermore, the memory 2220 may store control information or data included in a signal transmitted or received by the base station. The memory 2220 may include storage media, such as ROM, RAM, hard discs, CD-ROM, and DVDs, or a combination thereof. In addition, the memory 2220 may include multiple memories. According to an embodiment, the memory 2220 may store a program for performing the method of scheduling the UE according to whether the access carrier communicates with the UE or the data carrier communicates with the UE, which corresponds to the above-described embodiments of the disclosure.

According to various embodiments of the disclosure, a first transmission reception point (TRP) in a wireless communication system may include at least one transceiver and a controller coupled to the at least one transceiver, wherein the controller is configured to transmit, to a terminal, a first signal including information on one or more TRPs operating in a frequency band differing from that of the first TRP, receive, from the terminal, a random access preamble including information on at least one TRP that is preferred by the terminal and determined based on the first signal, in case that the first TRP determines, based on the information on the at least one TRP, a second TRP, transmit a signal instructing the second TRP to switch to a switch-on state, and transmit a signal instructing the terminal to perform a random access procedure with the second TRP.

According to an embodiment, the controller may be further configured to transmit, to an access mobility and management function (AMF) node, information on the at least one TRP preferred by the terminal and included in the random access preamble, and in case that the AMF determines, based on the information on the at least one TRP, the second TRP, receive, from the AMF, a signal instructing to manage the terminal as the second TRP.

According to an embodiment, the at least one TRP preferred by the terminal may be determined based on a location of the terminal or a pre-configured correlation.

According to an embodiment, the first signal may include at least one of an SSB or a CSI-RS.

According to an embodiment, the controller may be further configured to receive, from the second TRP, a response signal indicating reception of the signal instructing to switch to the switch-on state.

According to various embodiments of the disclosure, a second transmission reception point (TRP) in a wireless communication system may include at least one transceiver and a controller coupled to the at least one transceiver, wherein the controller is configured to receive a signal instructing to switch a switch state of the second TRP, perform, based on the received signal, switching of the switch state, in case that the switched switch state corresponds to a state in which transmission and reception functions of the second TRP are activated, transmit a first signal to a terminal, and receive, based on the first signal, a random access preamble from the terminal.

According to an embodiment, the signal instructing to switch the switch state may include a signal received from a first transmission reception point (TRP) operating in a frequency band differing from that of the second TRP.

According to an embodiment, the signal instructing to switch the switch state may include a signal received from an access mobility and management function (AMF).

According to an embodiment, the switched switch state corresponds to a state in which only a reception function of the second TRP is activated, and the controller may be further configured to activate, based on the random access preamble received from the terminal, a transmission function of the second TRP, and transmit the first signal to the terminal.

According to an embodiment, the first signal may include at least one of an SSB or a CSI-RS.

According to various embodiments of the disclosure, a method performed by a first transmission reception point (TRP) in a wireless communication system may include transmitting, to a terminal, a first signal including information on one or more TRPs operating in a frequency band differing from that the first TRP, receiving, from the terminal, a random access preamble including information on at least one TRP preferred by the terminal and determined based on the first signal, in case that the first TRP determines, based on the information on the at least one TRP, a second TRP, transmitting, to the second TRP, a signal instructing to switch to a switch-on state, and transmitting, to the terminal, a signal instructing to perform a random access procedure with the second TRP.

According to an embodiment, the method may further include transmitting, to an access mobility and management function (AMF) node, information on the at least one TRP preferred by the terminal and included in the random access preamble, and in case that the AMF determines, based on the information on the at least one TRP, the second TRP, receiving, from the AMF, a signal instructing to manage the terminal as the second TRP

According to an embodiment, the at least one TRP preferred by the terminal may be determined based on a location of the terminal or a pre-configured correlation.

According to an embodiment, the first signal may include at least one of an SSB or a CSI-RS.

According to an embodiment, the method may further include receiving, from the second TRP, a response signal indicating reception of the signal instructing to switch to the switch-on state.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Further, although exemplary embodiments of the disclosure have been described and shown in the specification and the drawings by using particular terms, they have been used in a general sense merely to easily explain the technical contents of the disclosure and help understanding of the disclosure, and are not intended to limit the scope of the disclosure. It will be apparent to those skilled in the art that, in addition to the embodiments disclosed herein, other variants based on the technical idea of the disclosure may be implemented. Furthermore, the above respective embodiments may be employed in combination, as necessary.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

What is claimed is:

1. An apparatus of a first transmission reception point (TRP) in a wireless communication system, the apparatus comprising:
at least one transceiver; and
a controller coupled to the at least one transceiver, and configured to:
transmit, to a terminal, a first signal comprising information on one or more TRPs operating in a frequency band differing from that of the first TRP;
receive, from the terminal, a random access preamble comprising information on at least one TRP that is preferred by the terminal and determined based on the first signal;
in case that the first TRP determines, based on the information on the at least one TRP, a second TRP, transmit a signal instructing the second TRP to switch to a switch-on state; and
transmit, to the terminal, a signal instructing to perform a random access procedure with the second TRP.

2. The apparatus of claim 1, wherein the controller is further configured to:
transmit, to an access mobility and management function (AMF) node, information on the at least one TRP preferred by the terminal and included in the random access preamble; and
in case that the AMF determines, based on the information on the at least one TRP, the second TRP, receive, from the AMF, a signal instructing to manage the terminal as the second TRP.

3. The apparatus of claim 1, wherein the at least one TRP preferred by the terminal is determined based on a location of the terminal or a pre-configured correlation.

4. The apparatus of claim 1, wherein the first signal comprises at least one of an SSB or a CSI-RS.

5. The apparatus of claim 1, wherein the controller is further configured to receive, from the second TRP, a response signal indicating reception of the signal instructing to switch to the switch-on state.

6. An apparatus of a second transmission reception point (TRP) in a wireless communication system, the apparatus comprising:
at least one transceiver; and
a controller coupled to the at least one transceiver, and configured to:
receive a signal instructing to switch a switch state of the second TRP;
perform, based on the received signal, switching of the switch state;
in case that the switched switch state corresponds to a state in which transmission and reception functions of the second TRP are activated, transmit a first signal to a terminal; and
receive, based on the first signal, a random access preamble from the terminal.

7. The apparatus of claim 6, wherein the signal instructing to switch the switch state comprises a signal received from a first transmission reception point (TRP) operating in a frequency band differing from that of the second TRP.

8. The apparatus of claim 6, wherein the signal instructing to switch the switch state comprises a signal received from an access mobility and management function (AMF).

9. The apparatus of claim 6, wherein the switched switch state corresponds to a state in which only a reception function of the second TRP is activated, and
wherein the controller is further configured to:
activate, based on the random access preamble received from the terminal, a transmission function of the second TRP; and
transmit the first signal to the terminal.

10. The apparatus of claim 6, wherein the first signal comprises at least one of an SSB or a CSI-RS.

11. A method performed by a first transmission reception point (TRP) in a wireless communication system, the method comprising:
transmitting, to a terminal, a first signal comprising information on one or more TRPs operating in a frequency band differing from that of the first TRP;
receiving, from the terminal, a random access preamble comprising information on at least one TRP preferred by the terminal and determined based on the first signal;
in case that the first TRP determines, based on the information on the at least one TRP, a second TRP, transmitting, to the second TRP, a signal instructing to switch to a switch-on state; and
transmitting, to the terminal, a signal instructing to perform a random access procedure with the second TRP.

12. The method of claim 11, further comprising:
transmitting, to an access mobility and management function (AMF) node, information on the at least one TRP preferred by the terminal and included in the random access preamble; and
in case that the AMF determines, based on the information on the at least one TRP, the second TRP, receiving, from the AMF, a signal instructing to manage the terminal as the second TRP.

13. The method of claim 11, wherein the at least one TRP preferred by the terminal is determined based on a location of the terminal or a pre-configured correlation.

14. The method of claim 11, wherein the first signal comprises at least one of an SSB or a CSI-RS.

15. The method of claim 11, further comprising receiving, from the second TRP, a response signal indicating reception of the signal instructing to switch to the switch-on state.
